(19) United States
(12) Patent Application Publication
(10) Pub. No.: US 2009/0306257 A1
(43) Pub. Date: Dec. 10, 2009

(54) Stabilizer System for Halogenated Polymers

(76) Inventors: Wolfgang Wehner, Zwingenberg (DE); Thomas Wannemacher, Taufkirchen (DE); Trupti Dave, Zwingenberg (DE)

Correspondence Address: O'BRIEN JONES, PLLC, 8200 Greensboro Drive, Suite 1020A, McLean, VA, 22102, US

(21) Appl. No.: 11/658,881

(22) PCT Filed: Jul. 26, 2005
(86) PCT No.: PCT/EP2005/008106

§ 371 Date: Jun. 16, 2009

(30) Foreign Application Priority Data
Jul. 30, 2004 (DE) 10 2004 037 369.8

(51) Int. Cl. C09K 15/20; C08K 5/34

(52) U.S. Cl. 524/100; 252/405; 252/400.1

(57) ABSTRACT

The stabilizer system for chlorine-containing polymers, in particular PVC, comprises at least one linear or cyclic acylureide (A-1) and/or a polyaminocrotonic ester (A-2)

and
a polyepoxypropyl alcohol ether (B-1) and/or a cyanamide (derivative) (B-2).

The stabilizer system may additionally comprise a sterically hindered amine (D) or a tertiary ethanolamine (E) and/or a perchlorate (C-1), perfluoroalkanesulfonate (C-2) and/or sulfate ester (C-3) salt.

A typical example is a combination of N,N′-dimethyl-6-iminobarbituric acid as component (A-1), trisepoxypropylglycerol as component (B-1) or dicyandiamide as component (B-2). This combination additionally comprises sodium or potassium perchlorate as component (C-1).

Further variants of the invention are the preparation of the stabilizer system, polymer compositions comprising the stabilizer system and utility articles thereof, such as window profiles or wire sheaths.

The invention relates to a stabilizer system for halogen-containing polymers and a process for stabilizing halogen-containing polymers. The polymer is in particular PVC.

It is known that halogen-containing plastics or molding materials prepared therefrom tend to undergo degradation or decomposition reactions if they are exposed to thermal load or come into contact with high-energy radiation, for example ultraviolet light.

Heavy metal-containing stabilizers based on Cd, Pb, Sn and Zn or, toxicologically unsafe metals, such as barium, have been used to date in practice for stabilizing, for example, PVC prior to processing. In these cases, the already harmful effect—with regard to improved absorbability and tolerance in a warm-blooded organism—is additionally increased by conversion into organic metal compounds based on fatty acids, e.g. laurates, stearates and oleates, or by transformation into organo derivatives (organometallic compounds or metal organyls), in particular in the case of tin. Especially in the last case, a system which is resistant to gastric juice and has capabilities of passing through the blood-brain barrier in order to display the possibly neurotoxic potential is created by the alkylation of the metal with the formation of a metal-carbon bond stable to hydrolysis even under metabolic conditions.

This problem relates not only to the users of finished PVC articles but also to their manufacturers who incorporate such heavy metal-containing stabilizers into the PVC substrate. The producers of these stabilizers themselves, who convert heavy metal-containing precursors into these very stabilizers, are also affected.

In addition to the toxic effect on the warm-blooded organism, these metals and their (organic) compounds or organo compounds have an “ecotoxic effect”, i.e. a harmful effect on fish, crabs and other saltwater and freshwater organisms; cf. “List of Priority Hazardous Substances”, passed by the Third North Sea Conference (The Hague, March 1990). In this list, zinc is mentioned in addition to lead, cadmium, arsenic and mercury. Also see the publication by the German Federal Environment Agency “Maβnalunen nachhaltige Wasserwirtschaft [Measures for a sustainable water economy]” (last updated April/2000), in which organic tin compounds, zinc, lead, copper and cadmium are defined as problem areas and measures are prioritized. Furthermore, maximum amounts are specified for heavy metals, namely Pb, Cd, Cr, Cu, Ni, Hg and Zn, in the sewage sludge regulation of the German Federal Environment Agency (BGBl. I, page 1492, last updated on Apr. 25, 2002). Inorganic heavy metal salts, too, can be converted into highly poisonous neurotoxic compounds via the biomethylation mechanism present in nature. Here, in particular trimethyllead and trimethyltin compounds come to mind. Organic stabilizers based on the elements C, H, N, O are converted in waste incineration into CO₂, H₂O and ammonium compounds, all of which are biocompatible. Heavy metal compounds on the other hand are not degraded, i.e. are persistent and hence exhibit bioaccumulation.

The replacement of heavy metal-containing stabilizers by organic compounds should therefore make an important contribution toward achieving this aim. In the UK and Denmark, the use of Pb stabilizers in PVC drinking water pipes was or will be banned from 2002 and 2003, respectively. In Denmark, this ban is additionally associated with the obligation not to use any Sn stabilizers instead of Pb stabilizers. Other countries, such as Sweden, Norway or Finland, intend to follow this ban. A EU-wide Pb ban is currently being negotiated by the competent authorities.

There is therefore a need for organic (green) stabilizers which are free of heavy metals and heavy metal compounds or other toxicologically unsafe metals and metal compounds, in particular completely free of lead, tin and barium.

As early as 1940, urea derivatives, such as N,N′-diphenylthiourea and monophenylurea, were described for stabilizing PVC (cf.: “Plastics Additives Handbook”, H. Zweifel, Carl Hanser Verlag, 5th Edition 2001, pages 427-483 and “Kunststoff-Handbuch PVC [Plastics Handbook PVC]”, Volume 2/1, W. Becker/D. Braun, Carl Hanser Verlag, 2nd Edition 1985, pages 531-534 and Kirk-Othmer: “Encyclopedia of Chemical Technology” 4^{th} Ed. 1994, Vol. 12, Heat Stabilizers, pages 1071-1091). However, these additives have only a limited range of use, for example for stabilizing emulsion PVC (Luvitherm process). In suspension PVC, their effect as a heat stabilizer proves to be insufficient, although it can be improved by addition of Sn soaps. The poor light stability also limits outdoor use.

Substituted indoles, such as 2-phenylindoles, are also used. Here too, however, use is limited owing to the poor light stability. In practice, combinations with zinc soaps have to be used in order to improve the heat stability.

Ureides in the form of the linear members are described as cyanoacetylureas (cyanoacetylcarbamides) or those in the form of (hetero)cycles are described as 6-amino-uracils. Cycloureides having a 6-iminobarbituric acid (barbiturimide) structure have not been mentioned to date.

Thus, EP 0,962,491 B1 mentions cyanoacetylureas as stabilizers for halogen-containing polymers. Combinations with costabilizers, mainly based on metal, are also described there.

Combinations of 6-aminouracils with costabilizers, which, however, are likewise mainly metal compounds (synthetic minerals) have also been published. Thus, EP 1,327,661 A1 describes 6-aminouracil combinations with dawsonites. EP 1,327,658 A1 mentions 6-aminouracil combinations with organotin compounds. EP 1,327,662 A1 publishes 6-aminouracil combinations with alkali metal and alkaline earth metal hydroxides. EP 1,325,941 A1 publishes 6-aminouracil combinations with zeolites. EP 1,046,668 B1 mentions 6-aminouracil combinations with hydrotalcites. EP 0,930,332 B1 claims 6-aminouracil combinations with further Ca/Al and Li/Al/Ti compounds.

Further ureides are described in EP 768 336 B1, DE 197 41 778 A1, EP 1 044 968 A1, EP 967 208 B1 and EP 0 967 209 B1.

EP 0,625,546 B1 protects the combination of Zn salts of fatty acids with glycidyl compounds for semirigid and flexible PVC. EP 0,677,550 B1 names combinations of glycidyl compounds, antioxidants and sodium perchlorate. EP 0,677,551 A2 claims compositions comprising glycidyl compounds and perchlorate salts for stabilizing flexible PVC. All three publications operate in practice in the presence of zinc soaps and glycidyl phenol ethers or N-glycidyl compounds. Moreover, the use is generally limited to semirigid and flexible PVC. Mixtures free of heavy metals (i.e. total omission of Zn salts) are not described here.

EP 1,327,659 A1 names 6-aminouracil combinations with glycidyl compounds, zinc compounds being practically dispensed with. From the class consisting of the glycidyl ethers, only diglycidyl phenyl ethers (for example BADGE) are recorded there by way of example. WO 02/072684 A1 mentions aminocrotonic acid ester combinations with perchlorate salts. Here too, attention is additionally focused on metal-containing costabilizers. In a multiplicity of applications, however, a reduced metal content is important, for example in the production of cables and insulators.

Owing to the heavy metal content, combinations with organotin stabilizers are not without problems. Combinations with glycidyl phenyl ethers, in particular based on BADGE and BFDGE, are controversial for toxicological and ecological reasons.

Dicyandiamide (DCN) or cyanoguanidine (CGN) has also been described as a stabilizer component in combination with heavy metal compounds or other toxicologically problematic substances. GB 1 077 018 and U.S. Pat. No. 3,309,338 claim mixtures with chrysotile asbestos. DD 117,327 discloses combinations with dibasic lead stearate or phthalate. BE 667,358 claims DCN, melamine, guanidine or benzoguanamine in combination with asbestos in a vinyl chloride/vinyl acetate copolymer. DD 140,464 contains combinations of DCN with barium/cadmium salts. DE 1,921,773 describes a cable application of DCN/lead salt mixtures. K. Thinius et al. have published, in Plaste u. Kautschuk [Plastics and Rubber] 9, 516-520 [1962], the mixture of DCN with zinc octenoate or stearate. However, the effect appears to be limited only to flexible PVC. Finally, it should be mentioned that DE 3,212,336 claims DCN in combination with water-eliminating metal salts (hydrates). In this case too, the effectiveness is proven only in flexible PVC.

EP 0,174,412 A1 describes combinations of dicyandiamide with substituted benzamides and operates in the absence of zinc salts. In practice, however, this procedure is limited to the use of E-PVC, the light stability proving to be insufficient.

All these combinations mentioned have serious disadvantages, whether the use in combination with carcinogenic substances, such as asbestos, or the combination with toxic metal compounds which contain lead, cadmium or barium; or whether use being limited to PVC copolymers or plasticized PVC. Heavy metal-free formulations with PVC homopolymers or applications in rigid PVC are, however, not described for DCN or melamine.

It is therefore an object of the present invention to provide combinations of substances which are distinguished by good properties with regard to heat stabilization and photostabilization of halogen-containing polymers, in particular PVC, with minimizaiton of “plate-out” and exudation behavior, in particular in rigid PVC. Furthermore, there is a need to process flexible PVC as plastisol, especially “crash pad” (“slush mold”) techniques also being used. In many cases, it is also necessary to impart antistatic properties and recyclability to the finished article. In addition, the novel systems should be economical and available in a wide range on an industrial scale (bulk chemicals) and should prevent tailor-made solutions in polymer applications. A further requirement is to develop combinations of substances which make it possible to stabilize in particular PVC during the polymerization process and the subsequent purification and drying process (so-called prestabilization).

This object is achieved by a stabilizer system for halogen-containing polymers containing a linear and/or cyclic ureide of the formula (A-1) and/or a polyaminocrotonic acid ester of the formula (A-2):

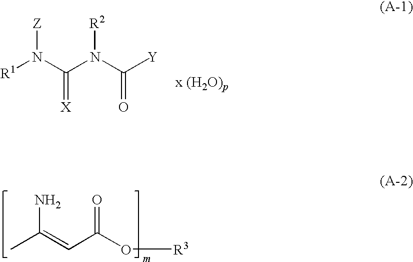

and
a polyepoxypropyl alcohol ether of the formula (B-1) and/or a cyanamide of the formula (B-2):

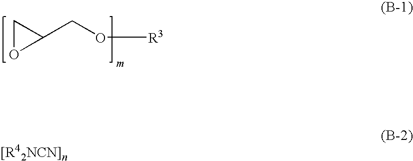

where
X═O or S; Y═CH₂CN, Z=H or Y and Z form the bridge member CH₂—C═NH or CR⁵═C—NHR⁶; m=2, 3, 4, 5 or 6 and n=1, 2 or 3 and p=0, 1, 2 or 3.
R¹, R²=independently of one another H, C₁-C₂₂-alkyl, cyclohexyl, (meth)allyl, oleyl, phenyl, benzyl, phenethyl, (tetrahydro)naphthyl, meth(eth)oxy(ethyl)propyl, CH₂—CHOH—R^{1a}, CH₂—CHOH—XR^{1a}
R^{1a}=H, C₁₋₂₂-alkyl, cyclohexyl, (meth)allyl, oleyl, phenyl, benzyl, phenethyl, (tetrahydro)naphthyl or meth(eth)oxy(ethyl)propyl;
R³=straight-chain or branched C₂-C₂₀-alkylene which may be interrupted by 1 to 4 O or S atoms and/or substituted by 1 to 40H groups, or dimethylolcyclohexane-1,4-diyl, polyethylene(propylene)glycol-α,ω-diyl (tetra to deca), polyglyceryl-α,ω-diyl (tetra to deca) or glyceroltriyl, trimethylolethane(propane)triyl, pentaerythritol-tri(tetra)yl, bistrimethylolethane(propane)tri(tetra)yl, diglycerol-tri(tetra)yl, tetritol-tetrayl, triglycerol-tri(tetra, penta)yl, pentitol-pentayl, dipentaerythritol-penta(hexa)yl and hexitol-hexayl;
R⁴=independently of one another H, nitrile, carbamoyl, R¹, R², R¹CO, R²CO, Na, K, Mg_{1/2} and Ca_{1/2} or R₂⁴=tetra-, penta- or hexamethylene;
R⁵═H or (C₃-C₁₀-alkylidene)_{1/2}; it being possible for this alkylidene to be interrupted by up to 2 O atoms or to have up to 2 substituents independently selected from the group consisting of OH, phenyl and hydroxyphenyl;
R⁶═H, hydroxy-C₂-C₄-alkyl, 3-C₁-C₁₀-alkoxy-2-hydroxypropyl or mono- or trihydroxy-, mono- to tri-C₁-C₄-alkyl- and/or mono- to tri-C₁-C₄-alkoxyphenyl, allyl, mono- to trisubstituted phenyl.

The radicals stated in brackets are further alternative radicals; thus, polyethylene(propylene) glycol means polyethylene glycol or polypropylene glycol. This also applies below.

Also surprising was the finding that the transparency behavior is improved by the combination of cycloureides, in particular with R¹=R²═CH₃ and (B-2). Thus, degrees of transparency more than 90% can be achieved with the use of otherwise transparency-imparting formulation constituents.

Preferred definitions of the substituents, short formulae and indices are the following:

In the case of (A-1), X is O or S in all cases. In the case of linear ureides, Y is CH₂CN and Z is H. In the case of cycloureides, the bridge member Y-Z is CH₂—C═NH in the case of the barbiturimides and the bridge member Y-Z is CR⁵═C—NHR⁶ in the case of the 6-aminouracils. m is 2, 3, 4, 5 or 6 in the case of (A-2) and (B-1) and n is 1, 2 or 3 in the case of (B-2). For (A-1), p is 0 to 3. Substituents R¹ and R² may be C₁-C₂₂-alkyl, namely methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl and docosyl, it being possible for these radicals to be branched or straight-chain. C₁-C₈-Alkyl are preferred, methyl, ethyl, propyl and butyl being particularly preferred. Furthermore, R¹ and R² may be cyclohexyl, (meth)allyl, oleyl, phenyl, benzyl, phenethyl, methoxyethyl, ethoxyethyl, methoxypropyl and ethoxypropyl. Allyl and phenethyl, cyclohexyl, benzyl, methoxypropyl and ethoxypropyl are preferred, and cyclohexyl, benzyl, methoxypropyl and ethoxypropyl are particularly preferred.

X is preferably 9 and particularly preferably R¹ is CH₃ and R² is CH₂—CHOH—R^{1a}, in which R^{1a} is preferably H, CH₃, C₂H₅ or R² is CH₂—CHOH—CH₂OR^{1a}, in which R^{1a} is preferably H or C₁-C₁₀-alkyl and allyl.

C₁-C₁₀-Alkyl contains, for example, methyl, ethyl, n-propyl, isopropyl, n-butyl, isobutyl, sec-butyl, tert-butyl, hexyl, heptyl, octyl, 2-ethylhexyl, nonyl, decyl or neodecyl.

R⁵ is hydrogen or (C₃-C₁₀-alkylidene)_{1/2}— the index ½ indicates that these are bis products, i.e. alkylidene bis-6-aminouracils. Ethylidene, propylidene, butylidene, pentylidene, hexylidene, heptylidene, octylidene, nonylidene and decylidene and salicylidene and cinnamylidene may be mentioned as alkylidene groups. The nomenclature applies to linear and branched members. Propylidene, hexylidene, heptylidene and octylidene are preferred. Hexylidene and heptylidene are particularly preferred.

The substituent R⁶ is named hydrogen and hydroxy-C₂-C₄-alkyl. The latter group contains 2-hydroxyethyl, 2- and 3-hydroxypropyl and 2-, 3- and 4-hydroxybutyl. 2-Hydroxyethyl and 2- and 3-hydroxypropyl are preferred. Hydrogen is particularly preferred.

Furthermore, R⁶ is allyl or 3-C₁-C₁₀-alkoxy-2-hydroxypropyl. This includes 3-methoxy-, 3-ethoxy-, 3-propoxy-, 3-butoxy-, 3-pentyloxy-, 3-hexyloxy-, 3-heptyloxy-, 3-octyloxy-, 3-nonyloxy- and 3-decyloxy-2-hydroxypropyl. Allyl-, 3-butoxy-, 3-octyloxy and 3-decyloxy-2-hydroxypropyl are preferred.

The substituents R⁶ are moreover mono- to trisubstituted phenyl, it being possible for the substituents to be hydroxyl and/or C₁-C₄-alkyl and/or C₁-C₄-alkoxy, and the combination hydroxyl with methyl, ethyl, propyl and butyl and hydroxyl with methoxy, ethoxy, propoxy and butoxy. The hydroxy, methyl, butyl, methoxy and ethoxy radical are preferred as a substituent. The hydroxyl and methoxy group are particularly preferred. Mono- and disubstitution are preferred. However, monosubstitution is particularly preferred. The combinations hydroxyl with meth(eth)oxy or hydroxyl with monomethyl or dimethyl and the combinations of methyl, ethyl, propyl and butyl with methoxy, ethoxy, propoxy and butoxy are likewise particularly preferred in the case of polysubstitution. The following may be mentioned specifically: 2-, 3- and 4-hydroxyphenyl; 2-hydroxy-4-methylphenyl; 2-hydroxy-5-methylphenyl; 2-hydroxy-5-tert-butylphenyl; and 2-, 3- and 4-meth(eth)oxyphenyl.

The compounds (A-1) may also be present as hydrates. This is preferred where Y and Z form CR⁵═C—NR⁶; particularly preferably for R¹ and/or R²≠methyl. The hydrates may be present, for example, as the hemihydrate, sesquihydrate or dihydrate.

For (A-2) and (B-1) containing R³ as C₂-C₂₀-alkylene which may be interrupted by 1 to 4 O or S atoms and/or substituted by 1 to 40H groups, ethane-1,2-diyl, propane-1,2-diyl, propane-1,3-diyl, butane-2,3-diyl, butane-1,4-diyl, CH₂CH₂OCH₂CH₂, CH₂CH₂OCH₂CH₂OCH₂CH₂, CH₂CH₂SCH₂CH₂, CH₂CH₂OCH₂CH₂OCH₂CH₂OCH₂CH₂, CH₂CH₂SCH₂CH₂SCH₂CH₂, C₃H₆C₃H₆, C₃H₆OC₃H₆OC₃H₆C₃H₆OC₃H₆OC₃H₆ OC₃H₆OC₃H₆CH₂CHOHCH₂OCH₂CHOHCH₂, CH₂CHOHCH₂OCH₂CHOHCH₂OCH₂CHOHCH₂ are preferred. CH₂CH₂CH₂CH₂ and CH₂CH₂SCH₂CH₂ are particularly preferred. Tetritol is preferably erythritol, arabinitol and xylitol, and hexitol is preferably mannitol and sorbitol.

Depending on the degree of oligomeration n, (B-2) is cyanamide or a derivative thereof, dicyandiamide or a derivative thereof or melamine or a derivative thereof; here, the primary NH₂ group may be present in unsubstituted, monosubstituted or disubstituted form, it being possible for the substituent to be alkyl, phenyl or acyl, or both substituents together being tetra-, penta- and hexamethylene.

R⁴ as R¹CO is preferably formyl, acetyl, propionyl, butyroyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, octadecanoyl, oleoyl, acryloyl, crotonoyl, phenylacetyl, phenylpropionyl and carbamoyl. Acylcyanamides are preferred, in particular C₈-C₁₈-fatty acid acylcyanamides, as well as magnesium and calcium cyanamide. Dicyandiamide or an alkali metal or alkaline earth metal salt of an acylcyanamide is particularly preferred. Melamine may also be present as a salt in the form of the phosphate or isocyanurate salt.

Preferred members of the individual groups of substances are mentioned below. The nomenclature is not limiting but selective.

(A-1)—Linear acylureides (linear ureides, acylcarbamides, acylureas), such as [1] N,N′-dimethyl-, [2] N,N′-diethyl-, [3] N,N′-dipropyl-, [4] N,N′-diallyl-, [5] N,N′-dibutyl-, [6] N,N′-dioctyl-, [7] N,N′-didodecyl- and [8] N,N′-dibenzylcyanacetureide, [9] N- or N′-monomethyl-, [10] N- or N′-monoethyl-, [11] N- or N′-monopropyl-, [12] N- or N′-monoallyl-, [13] N or N′-monobutyl-, [14] N- or N′-monopentyl-, [15] N- or N′-monohexyl-, [16] N- or N′-monoheptyl- and [17] N- or N′-monooctyl-, [18] N,N′-monocyclohexyl-[19] N,N′-monobenzyl- and [20] N,N′-monophenylcyanoacetureide. [1], [2], [3], [4], [5], [8], [9], [10], [11], [12], [13], [18], [19] and [20] are preferred. [1], [4], [8], [12], [18], [19] and [20] are particularly preferred. [1] is very particularly preferred.

(A-1)—Cycloacylureides (cycloureides, 6-iminobarbituric acids or 6-barbiturimides or 6-iminohydrouracils or 6-iminodihydropyrimidine-2,4-diones), such as [21] (CAS No. 17743-04-3) N,N′-dimethyl-, [22] N,N′-diethyl-, [23] N,N′-dipropyl-, [24] N,N′-diallyl-, [25] N,N′-dibutyl-, [26] N,N′-dioctyl- and [27] N,N′-didodecyl- and [28] N,N′-dibenzyl-6-iminobarbituric acid, [29] (CAS No. 17743-03-2 and 17743-02-1) N- or N′-monomethyl-, [30] N- or N′-monoethyl-, [31] N- or N′-monopropyl-, [32] N- or N′-monoallyl-, [33] N- or N′-monobutyl-, [34] N- or N′-monopentyl-, [35] N- or N′-monohexyl-, [36] N- or N′-monoheptyl-[37] N- or N′-monooctyl-, [38] N or N′-monocyclohexyl- or [39] N or N′-monophenyl- and [40] N,N′-monobenzyl-6-iminobarbituric acid. [21], [22], [23], [24], [25], [28], [29], [30], [31] [32], [33], [37], [38], [39] and [40] are preferred. [21], [24], [28], [32], [37], [38], [39] and [40] are particularly preferred. [21] is very particularly preferred. A cycloureide is furthermore preferred, in particular an N- or N′-substituted or (N,N′)-disubstituted 6(4)-iminobarbituric acid.

(A-1)—Cycloacylureides (6-aminouracils or 6(4)-aminopyrimidine-2,4-diones), such as [41] N,N′-dimethyl-, [42] N,N′-diethyl-, [43] N,N′-dipropyl-, [44] N,N′-diallyl-, [45] N,N′-dibutyl-, [46] N,N′-dioctyl- and [47] N,N′-didodecyl- and [48] N,N′-dibenzyl-6-aminouracil, [49] N- or N′-monomethyl-, [50] N- or N′-monoethyl-, [51] N- or N′-monopropyl-, [52] N- or N′-monoallyl-, [53] N- or N′-monobutyl-, [54] N- or N′-monopentyl-, [55] N- or N′-monohexyl-, [56] N- or N′-monoheptyl-, [57] N- or N′-monooctyl-, [58] N- or N′-monocyclohexyl-, [59] N or N′-monobenzyl- and [60] N or N′-monophenyl-6-aminouracil. [41], [42], [43], [44], [45], [48], [49], [50], [51], [52], [53], [57], [58], [59] and [60] are preferred. [41], [44], [48], [52], [57], [58], [59] and [60] are particularly preferred. [41] is very particularly preferred.

Preferred hydrates are the hemihydrate and monohydrate of [42], [43], [44] and [45].

This category furthermore includes the 6-aminouracils substituted on the exocyclic N atom, such as hydroxyethylamino and hydroxypropylamino derivatives or hydroxyanilino, methoxyanilino and ethoxyanilinouracils. [61,62,63] N-2-, -3- and -4-hydroxyphenyl-1,3-dimethyl-6-aminouracil and [64] N-2-hydroxy-4-methylphenyl-, [65] N-2-hydroxy-5-methylphenyl-, [65] N-2-hydroxy-5-tert-butylphenyl-, [66,67,68] N-2-, -3- and -4-methoxyphenyl-, [69,70,71] N-2-, -3- and -4-ethoxyphenyl-1,3-dimethyl-6-aminouracil, [72] N-2-hydroxyethylamino-, [73] N-2-hydroxypropylamino-, [74] N-3-hydroxypropylamino-, [75] N-2-hydroxybutylamino-, [76] N-3-hydroxybutylamino- and [77] N-4-hydroxybutylamino-1,3-dimethyl-6-aminouracil may furthermore be mentioned. [61], [64], [65], [66], [69], [72], [73] and [74] are preferred. [61], [64], [65], [66] and [69] are particularly preferred. [61], [66] and [69] are very particularly preferred. 6-Aminouracils substituted in the 5-position, such as alkylidenebis-6-aminouracils, must likewise be mentioned here. [78] 5-Ethylidene-, [79] 5-propylidene-, [80] 5-(2-ethylbutylidene)-, [81] 5-hexylidene-, [82] 5-heptylidene-, [83] 5-octylidene-, [84] 5-benzylidene-, [85] 5-salicylidene-, [86] 5-(3-hydroxy)benzylidene-, [87] 5-(4-hydroxy)benzylidene- and [88] 5-(2-hydroxy)-3-methoxy)benzylidene- and [89] 5-pentylidenebis-1,3-dimethyl-6-aminouracil may be listed. [80], [81], [82], [83] and [89] are preferred.

[81], [82], [83] and [89] are particularly preferred. [81] and [82] are very particularly preferred.

By reacting N-monosubstituted 6-aminouracils with C-glycidyl compounds and glycidyl (thio)ethers or esters, N,N′-disubstituted 6-aminouracils form. The following may be mentioned specifically: [90] 1-methyl-3-(3-isopropoxy-2-hydroxypropyl)-, [91] 1-phenyl-3-(3-isopropoxy-2-hydroxypropyl)-, [92] 1-methyl-3-(3-tert-butoxy-2-hydroxypropyl)-, [93] 1-benzyl-3-(3-isopropoxy-2-hydroxypropyl)-, [94] 1-methyl-3-(3-neononylcarboxy-2-hydroxypropyl)-, [95] 1-methyl-3-(2-hydroxypropyl)-, [96] 1-methyl-3-(3-(2-ethylhexyloxy-2-hydroxypropyl)-, [97] 1-methyl-3-(2-hydroxyhexyl)-, [98] 1-benzyl-(2-hydroxypropyl)-, [99] 1-methyl-(2-hydroxybutyl)-, [100] 1-benzyl-(2-hydroxybutyl)-, [101] 1-benzyl-(3-isopropoxy-2-hydroxypropyl)-, [102] 1-methyl-3-(2-hydroxyethyl)- and [103] 1-methyl-3-(3-allyloxy-2-hydroxypropyl)-6-aminouracil. [90], [92], [94], [95], [96], [97], [99], [102] and [103] are preferred. [90], [92], [95], [99], and [103] are particularly preferred. [95], [99] and [103] are very particularly preferred.

Certain 6-aminouracils are available in the chemical trade: [1], [9] and [41] are “commodities” and are used as bulk chemicals in industrial caffeine or theobromine synthesis. For 6-iminobarbituric acids, relevant literature syntheses are available.

(A-2) Bisaminocrotonic acid esters of [104]ethylene glycol and [105] propylene glycol and of polyethylene glycols and polypropylene glycols and of [106] glycerol and polyglycerols. Trisaminocrotonic acid esters [107] glycerol, [108,109] trimethylolethane(propane), [110] triethylol isocyanurate. Tetrakisaminocrotonic acid

esters of [111] pentaerythritol, [112,113] bistrimethylolethane(propane), hexakis-aminocrotonic acid esters of [114] dipentaerythritol and [115] sorbitol, and [116] butanediyl-1,4- and [117] thiobisethanediyl aminocrotonate. [104], [105], [108], [109], [111], [113], [116] and [117] are preferred. [104], [105], [116] and [117] are particularly preferred. [116] and [117] are very particularly preferred. Both compounds are produced on an industrial scale.

(B-1) Bisepoxypropyl alcohol ethers of alkanediols, diglycols, tri- and tetraglycols (glycol=ethylene glycol or propylene glycol) and polyglycols and of [118] glycerol and polyglycerols. Trisepoxypropyl alcohol ethers of [119] glycerol and [120,121] trimethylolethane(propane) and tetrakisepoxypropyl alcohol ethers of [122,123] bis-trimethylolethane(propane) and hexakisepoxypropyl alcohol ethers of [124] dipentaerythritol and [125] sorbitol, [126] hexanediol and [127] neopentylglycol diglycidyl ether and [128]ethylene glycol diglycidyl ether, [129] diethylene glycol and [130] dipropylene glycol and polyglyceryl, [131] diglyceryl, [132] triglyceryl, [133] tetraglyceryl and [134] pentaglyceryl diglycidyl ether, [135] 1,4-butanediol diglycidyl ether, [136, 137] trimethylolethane(propane) diglycidyl ether and [138, 139] pentaerythrityl tri- and tetraglycidyl ether and polyglyceryl triglycidyl ether. [118], [119], [120], [121], [126], [127], [128], [129], [130], [131], [132], [133], [134] [135], [136], [137], [138] and [139] are preferred. [118], [119], [120], [121], [126], [127], [128], [129], [130], [135], [136], [137], [138] and [139] are particularly preferred. [118], [119], [120], [121], [135], [136], [137], [138] and [139] are very particularly preferred. Many compounds of this series are produced as bulk chemicals.

(B-2) Monomers: [140] Cyanamide and its salts, in particular [141] calcium cyanamide, [142] monomethyl-, [143] monoethyl-, [144] monopropyl-, [145] monobutyl-, [146] monopentyl-, [147] monohexyl-, [148] monoheptyl-, [149] monooctyl-, [150] monophenyl- and [151] monobenzylcyanamide and [152] monoallylcyanamide. [153] 1,1-Dimethyl-, [154] 1,1-diethyl-, [155] 1,1-dipropyl-, [156] 1,1-dibutyl-, [157] 1,1-dipentyl-, [158] 1,1-dihexyl-, [159] 1,1-diheptyl-, [160] 1,1-dioctyl-, [161] 1,1-diphenyl- and [162] 1,1-dibenzylcyanamide and [163] 1,1-diallylcyanamide. [164] Acetyl-, [165] propionyl-, [166] butyroyl-, [167] pentanoyl-, [168] hexanoyl-, [169]heptanoyl-, [170] octanoyl-, [171] nonanoyl-[172] decanoyl-, [173] undecanoyl-, [174] dodecanoyl-, [175] tridecanoyl-, [176] tetradecanoyl-, [177] pentadecanoyl-, [178] hexadecanoyl-, [179]heptadecanoyl-, [180] octadecanoyl-, [181] nonadecanoyl-, [182] eicosanoylcyanamide, [183] benzoylcyanamide and [184] tetradecyl-, [185] hexadecyl- and [186] octadecylcyanamide. Since cyanamides and cyanamide derivatives tend to decompose under certain circumstances in PVC processing, preliminary compounding in a hot mixer is advisable in the case of reactive members.

(B-2) Dimers: [187] Dicyandiamide and its substitution products and salts thereof.
The unsubstituted dicyandiamide is preferred.

(B-2) Trimers: Melamines and melamine salts, such as [188] melamine, [189] melamine perchlorate, [190] melamine oxalate, [191] melamine sulfate, [192] melamine nitrate, [193] melamine phosphate and [194] melamine isocyanurate.

N-Substituted melamines, such as [195] N-monobutyl-, [196] N-monooctyl-, [197] N-monodecyl-, [198] N-monododecyl-, [199] N-monotetradecyl-, [200] N-monohexadecyl-, [201] N-monooctadecyl- and [202] N-monophenylmelamine. And [203] N-monoacetyl-, [204] N-monopropionyl- and [205] N-monobutyroylmelamine, [206] N-monophenyl-, [207] N-monoallyl- and [208] N-monobenzylmelamine, [209] o-hydroxyphenylmelamine and [210,211] 2 -hydroxyethyl(propyl)melamine.

N,N′-Substituted melamines, such as [212] N,N′-dibutyl-, [213] N,N′-dioctyl-, [214] N,N′-didecyl-, [215] N,N′-dihexadecyl- and [216] N,N′-dioctadecylmelamine and [217,218] N,N′-bis-2-hydroxyethyl(propyl)melamine.

N,N′,N″-substituted melamines, such as [219] N,N′,N″-tributyl-, [220] N,N′,N″-trioctyl-, [221] N,N′,N″-tridecyl-, [222] N,N′,N″-tetradecyl, [223] N,N′,N″-trihexadecyl- and [224] N,N′,N″-trioctadecylmelamine and [225] N,N′,N″-phenylbishydroxyethyl- and [226] N,N′,N″-trishydroxyethylmelamine, [227] N,N′,N″-triacetyl-, [228] N,N′,N″-tripropionyl- and [229] N,N′,N″-tribenzoyhnelamine and [230] N,N′,N″-triallyl- and [231] N,N′,N″-tribenzylmelamine. [232] N,N′,N″-triphenylmelamine and [233] N,N,N″-tricyclohexylmelamine, [234] N,N′,N″-trishydroxypropylmelamine and [235] N,N′,N″-phenylbishydroxypropylmelamine.

The substances [141], [142], [143], [144], [150], [151], [153], [154], [155], [159], [162], [163], [164], [176], [178], [184], [185] and [186], [187] and [188] are preferred. [206], [207], [208], [209], [210], [211] are furthermore preferred. [217,218], [226], [227], [228], [229], [230] and [231] are likewise preferred.

[187], [188], [209], [210] and [211] are particularly preferred. [226] [227] [228] [229] [230] and [231] are furthermore particularly preferred.

[187] is very particularly preferred. [187] and its calcium and magnesium salt and [188] or [194] are commodities. The Ca and Mg salts can be synthesized in situ during the PVC process or prepared beforehand from magnesium hydroxide or potassium hydroxide during the compounding. For melting point depression on [187], eutectic mixtures with substituted ureas or aniline derivatives or with aminobenzenesulfonamides are particularly preferred.

Preferred two-component combinations are:

(A-1) R¹ or R² methyl, ethyl, cyclohexyl, allyl, benzyl or hydrogen and (B-1) bisepoxypropyl ether of a C₂-C₆-alkanediol, of a polyethylene(propylene)glycol or of glycerol or of a polyglycerol or a trisepoxypropyl ether of glycerol or of trimethylolethane(propane) or pentaerythrityl tetraglycidyl ether.

(A-1) R¹ or R²=methyl, ethyl, cyclohexyl or benzyl and (B-1) bisepoxypropyl ether of ethylene glycol, propylene glycol, butylene glycol or neopentyl glycol or of hexanediol or of glycerol or a trisepoxypropyl ether of glycerol or of trimethylolethane(propane) or pentaerythrityl tetraglycidyl ether.

(A-1) R¹ or R²=methyl, ethyl, cyclohexyl, allyl, benzyl or hydrogen and (B-2) R⁴=hydrogen, C₁-C₄-alkyl, phenyl, formyl, acetyl, benzoyl or sodium or R₂⁴ is tetra- or pentamethylene or calcium.

(A-1) R¹ or R²=methyl, ethyl, cyclohexyl or benzyl and (B-2) cyanamide, acetylcyanamide or the sodium or potassium salts thereof, dicyandiamide (cyanoguanidine) or 1,3,5-triaminotriazine (melamine).

(A-2) Bisaminocrotonic acid esters of 1,4-butanediol and/or of thiodiglycol and (B-1) bisepoxypropyl ether of ethylene glycol, propylene glycol, butylene glycol and neopentyl glycol or of hexanediol or of glycerol or a trisepoxypropyl ether of glycerol or trimethylolethane or -propane or pentaerythrityl tetraglycidyl ether.

(A-2) Bisaminocrotonic acid ester of 1,4-butanediol and/or thiodiglycol and (B-2) cyanamide, acetylcyanamide, dicyandiamide (cyanoguanidine) or 1,3,5-triaminotriazine (melamine).

Further preferred two-component combinations are:

Two-component combinations of (A-1) with (B-1), namely:

(A-1) Component—linear acylureides:

[1] with [118], [119], [120], [121], [135], [136], [137], [138] and [139]

(A-1) Component—cycloacylureides (6-iminobarbituric acids):

[21] with [118], [119], [120], [121], [135], [136], [137], [138] and [139]

(A-1) Component—Cycloacylureides (6-aminouracils):

[41] with [118], [119], [120], [121], [135], [136], [137], [138] and [139]
[61] with [118], [119], [120], [121], [135], [136], [137], [138] and [139]
[66] with [118], [119], [120], [121], [135], [136], [137], [138] and [139]
[69] with [118], [119], [120], [121], [135], [136], [137], [138] and [139]
[81] with [118], [119], [120], [121], [135], [136], [137], [138] and [139]
[82] with [118], [119], [120], [121], [135], [136], [137], [138] and [139]
[95] with [118], [119], [120], [121], [135], [136], [137], [138] and [139]
[99] with [118], [119], [120], [121], [135], [136], [137], [138] and [139]
[103] with [118], [119], [120], [121], [135], [136], [137], [138] and [139]

Two-component combinations of (A-2) with (B-1), namely:

[116] with [118], [119], [120], [121], [135], [136], [137], [138] and [139]
[117] with [118], [119], [120], [121], [135], [136], [137], [138] and [139]

Two-component combinations of (A-1) with (B-2), namely:

Linear acylureides: [1] with [187]

Cycloacylureides (6-iminobarbituric acids): [21] with [187]

Cycloacylureides (6-aminouracils)

[41] with [187], [61] with [187], [66] with [187], [69] with [187], [81] with [187], [82] with [187] [95] with [187], [99] with [187], [103] with [187]

Two-component combinations of (A-2) with (B-2), namely:

[116] with [187] and [117] with [187]

The compounds from the groups (A) and (B) are used in the halogen-containing polymer expediently in an amount from 0.01 to 10 phr, preferably from 0.05 to 5 and in particular from 0.1 to 3 phr.

Furthermore, three-component combinations consisting of the two-component combinations (A+B) and additionally a salt (C) are preferred, this salt (C) being a perchlorate salt (C-1), a perfluoroalkanesulfonate salt (C-2) or a C₁-C₁₈-alkylsulfuric acid monoester salt (C-3). These salts are suitably present as alkali metal or alkaline earth metal salts.

Perchlorate salt (C-1) is preferably alkali metal, alkaline earth metal, aluminum, hydrotalcite, katoite, hydroalumite and lithium hydrotalcite perchlorate, as described in EP 0,549,340 A1. [236] Li perchlorate, [237] Na perchlorate, [238] K perchlorate, [239] Mg perchlorate and [240] Ca perchlorate may be mentioned. Perfluoroalkanesulfonate salt (C-2) is preferably a salt of “triflic”, “pentaflic”, “heptaflic” and “nonaflic” acid; Na and K triflate or Mg or Ca and Al triflate and NH₄ triflate are very particularly preferred.

Sulfate ester salt (C-3) is preferably Li, Na, K, Mg, Ca, Sr, Ba, Ln, Ce, Al, Zn and NH₄ sulfate ester. Sulfate ester is sulfuric acid monoester; methyl, ethyl, propyl, butyl, hexyl, octyl, decyl, dodecyl, tetradecyl, hexadecyl, octadecyl and octadecenylsulfuric acid monoesters are preferred; Na methyl, octyl, decyl and dodecyl sulfate esters as well as the analogous K or Mg, Ca and Al salts are very particularly preferred. [246] Na butyl, [247] Na dodecyl, [248] Na hexadecyl, [249] Na octadecyl and [250] Na octyl sulfate may be mentioned by way of example.

The components (A-1), (A-2), (B-1), (B-2), (C-1), (C-3) are frequently bulk chemicals, so-called commodities.

Component (C-2) is generally available in the chemical trade. The salts like the parent acids are described in Kirk Othmer, Encyclopedia of Chemical Technology, 4th Ed., John Wiley & Sons., NY, Vol. 11, pages 558-564 (1994) and in Chem. Rev. 77, pages 69-90 (1977). [241] Li, [242] Na, [243] K, [244] Mg and [245] Ca triflate may be mentioned in particular.

Depending on water solubility or sparing water solubility, the components (C-1), (C-2) and (C-3) can be used in various customary administration forms (formulations), for example as a salt or as a solution in water or in an organic solvent or applied to a substrate material, such as PVC, calcium silicate, zeolites or hydrotalcites. Examples of such formulations are also corresponding salts which are complexed with alcohols (polyols, cyclodextrins) or ether alcohols, aminoalcohols or ester alcohols or crown ethers or are dissolved therein. Complexes or solutions in glycol monobutyl ether and diglycol monobutyl ether are preferred.

Another method of combining the components of the stabilizer systems according to the invention is based on the use of complexes (so-called amine complexes), for example complexes of Na or K perchlorate or triflate with triethanol- or triisopropanolamine or ethylene- or propyleneurea or ethylenethiourea, imidazolidinone or imidazolidinedione. In another variant, ethylene carbonate or propylene carbonate can be used as a solvent for these salts or complexes.

The compounds of category (C) are used in the halogen-containing polymer expediently in an amount from 0.001 to 5 phr, preferably from 0.01 to 3 phr and very particularly from 0.01 to 2 phr.

Among the classes of compounds mentioned as component (C), the perchlorates (C-1) and the triflates (C-2) are particularly preferred.

Advantageous three-component combinations are:

(A-2) a bisaminocrotonic acid ester of 1,4-butanediol and/or of thiodiglycol and (B-1) a bisepoxypropyl ether of ethylene glycol, propylene glycol, butylene glycol and neopentylglycol or of hexanediol or of glycerol or a trisepoxypropyl ether of glycerol, of trimethylolethane or trimethylolpropane or pentaerythrityl tetraglycidyl ether and a perchlorate salt (C-1).

(A-2) a bisaminocrotonic acid ester of 1,4-butanediol and/or of thiodiglycol and (B-2) cyanamide, acetylcyanamide, dicyandiamide (cyanoguanidine) or 1,3,5-triaminotriazine (melamine) and a perchlorate salt (C-1).

Three-component combinations of (A-1) with (B-1) and (C-1), namely:

Linear acylureides:

[1] with [118], [119], [120], [121], [135], [136], [137], [138], [139] and [237] or [238]

Cycloacylureides (6-iminobarbituric acids):

[21] with [118], [119], [120], [121], [135], [136], [137], [138], [139] and [237] or [238]

Cycloacylureides (6-aminouracils):

[41] with [118], [119], [120], [121], [135], [136], [137], [138], [139] and [237] or [238]
[61] with [118], [119], [120], [121], [135], [136], [137], [138], [139] and [237] or [238]
[66] with [118], [119], [120], [121], [135], [136], [137], [138], [139] and [237] or [238]
[69] with [118], [119], [120], [121], [135], [136], [137], [138], [139] and [237] or [238]
[81] with [118], [119], [120], [121], [135], [136], [137], [138], [139] and [237] or [238]
[82] with [118], [119], [120], [121], [135], [136], [137], [138], [139] and [237] or [238]
[95] with [118], [119], [120], [121], [135], [136], [137], [138], [139] and [237] or [238]
[99] with [118], [119], [120], [121], [135], [136], [137], [138], [139] and [237] or [238]
[103] with [118], [119], [120], [121], [135], [136], [137], [138], [139] and [237] or [238]

Three-component combinations (A-2) with (B-1) and (C-1), namely:

[116] with [118], [119], [120], [121], [135], [136], [137], [138], [139] and [237] or [238]
[117] with [118], [119], [120], [121], [135], [136], [137], [138], [139] and [237] or [238]

Three-component combinations (A-1) with (B-2) and (C-1), namely:

Linear acylureides: [1] with [187] and [237] or [238]

Cycloacylureides (6-iminobarbituric acids): [21] with [187] and [237] or [238]

Cycloacylureides (6-aminouracils)

[41] with [187], [61] with [187], [66] with [187], [69] with [187], [81] with [187], [82] with [187]
[95] with [187], [99] with [187], [103] with [187] and [237] or [238]

Three-component combinations of (A-2) with (B-2) and (C-1), namely:

[116] with [187] and [117] with [187] and [237] or [238]

One or more sterically hindered amines (D) may be added as further component (D) to the two-component or three-component combinations (A+B) or (A+B+C) according to the invention.

The sterically hindered amine is generally a compound containing the group

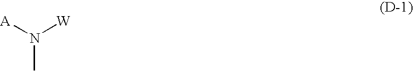

in which A and W, independently of one another, are C₁₋₈-alkyl, C₃₋₈-alkenyl, C₅₋₈-cycloalkyl or C₇₋₉-phenylalkyl or together form C₂₋₅-alkylene optionally interrupted by O, NH or CH₃—N, or is a cyclic sterically hindered amine, in particular a compound in the series consisting of the alkyl- or polyalkylpiperidines, especially the tetramethylpiperidines containing the group

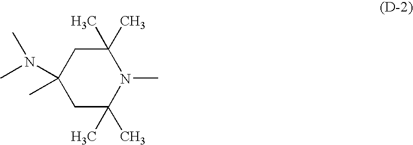

Examples of such polyalkylpiperidine compounds are the following (in the case of the oligomeric or polymeric compounds, n and r are in the range 2-200, preferably in the range 2-10, in particular 3-7):

01) N,N′-Bis(2,2,6,6-tetramethylpiperidin-4-yl)ethylene-1,2-diacetamide
01a) N,N′-Bis(2,2,6,6-tetramethylpiperidin-4-yl)hexamethylene-1,6-diacetamide
01b) N,N′-Bis(2,2,6,6-tetramethylpiperidin-4-yl)ethylene-1,2-diformamide
02) N,N′-Bis(2,2,6,6-tetramethylpiperidin-4-yl)adipamide
03) N,N′-Bis(2,2,6,6-tetramethylpiperidin-4-yl)oxamide
04) 4-Hydroxybenzamido-2,2,6,6-tetramethylpiperidine

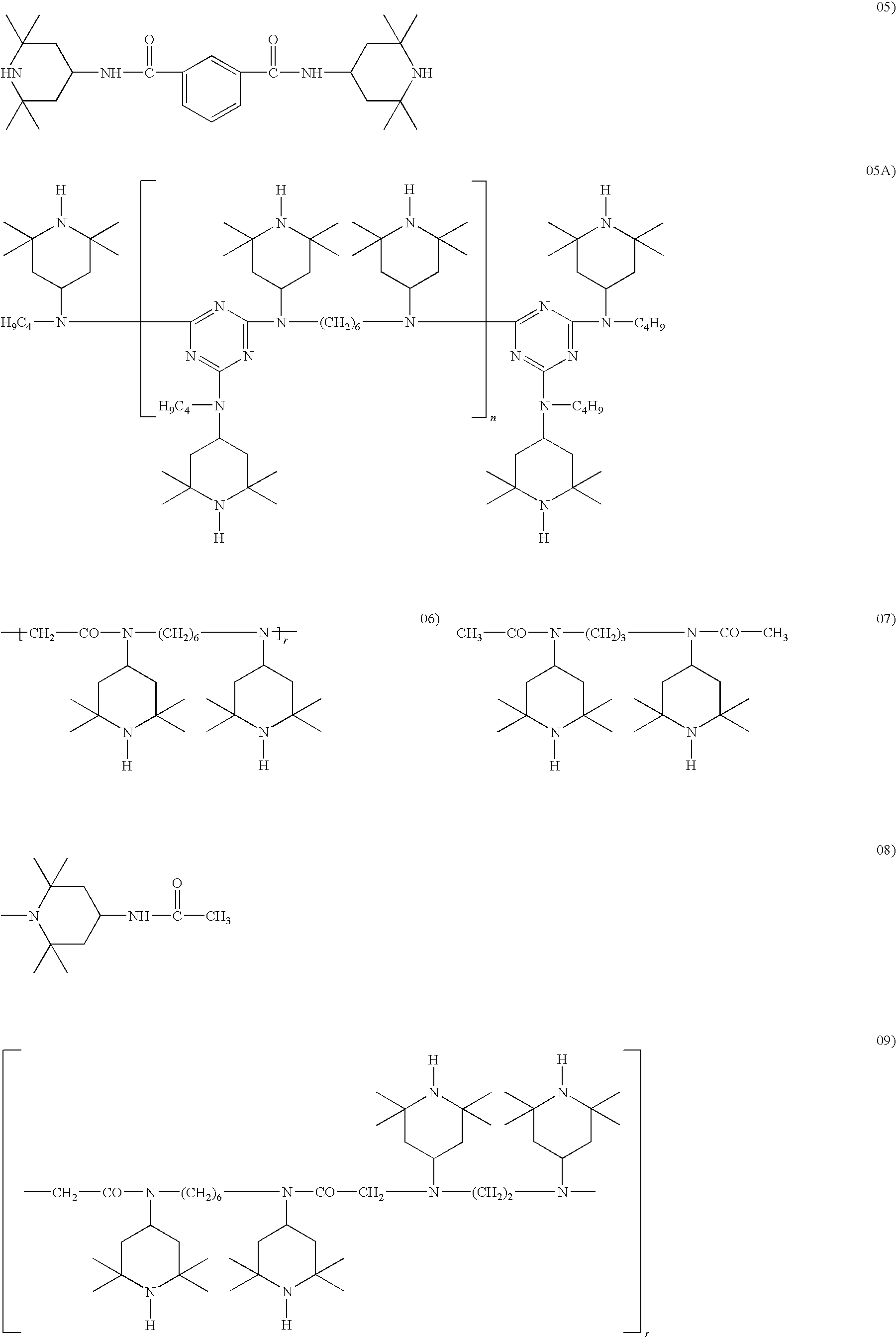

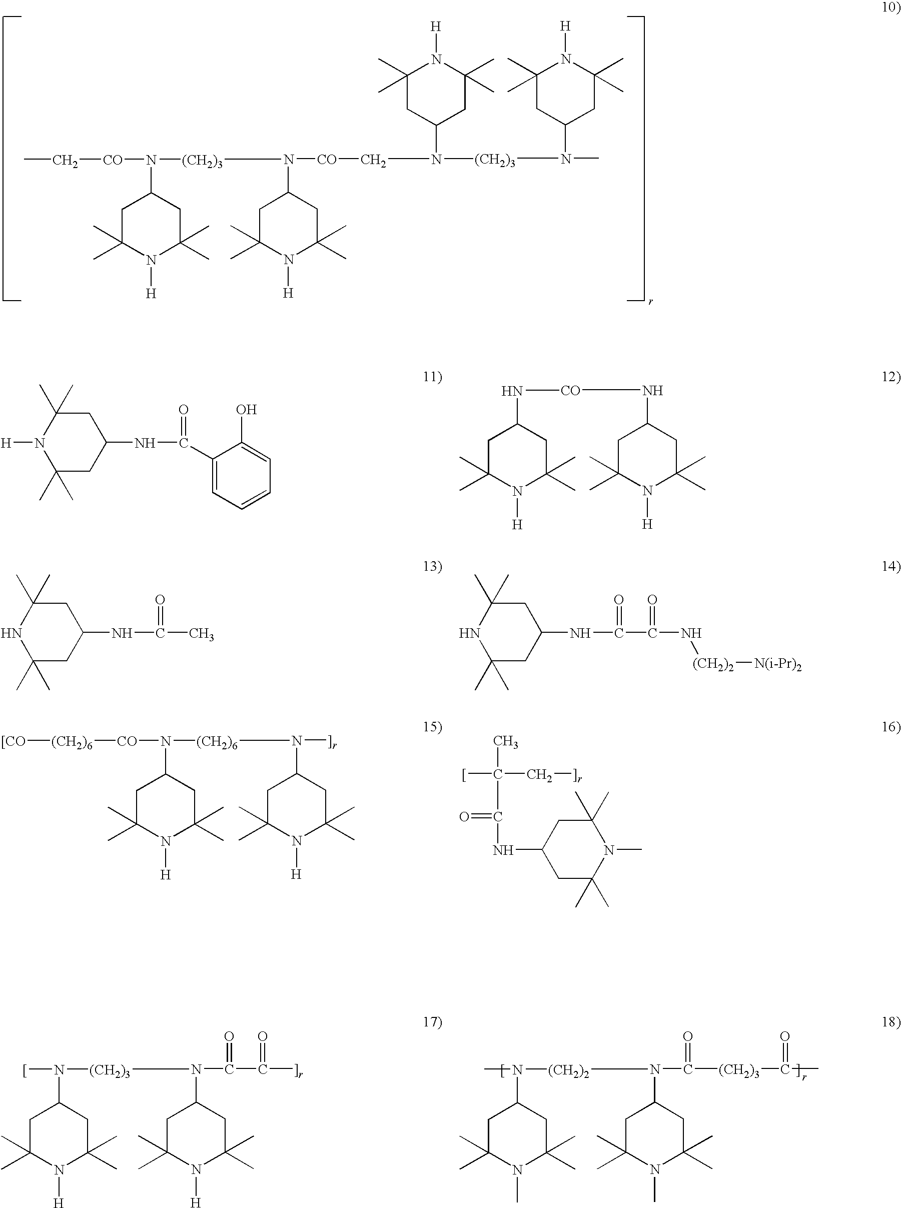

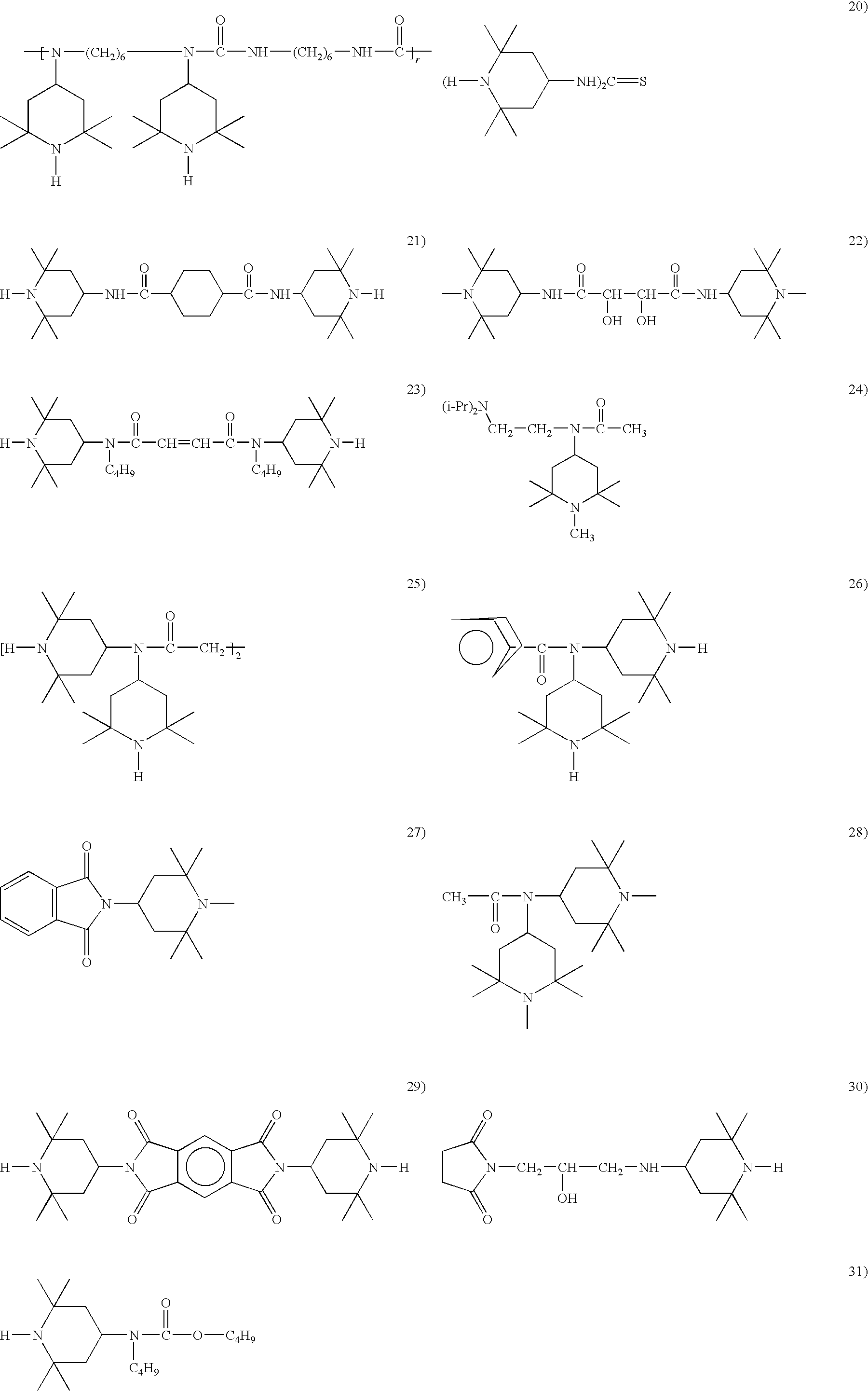

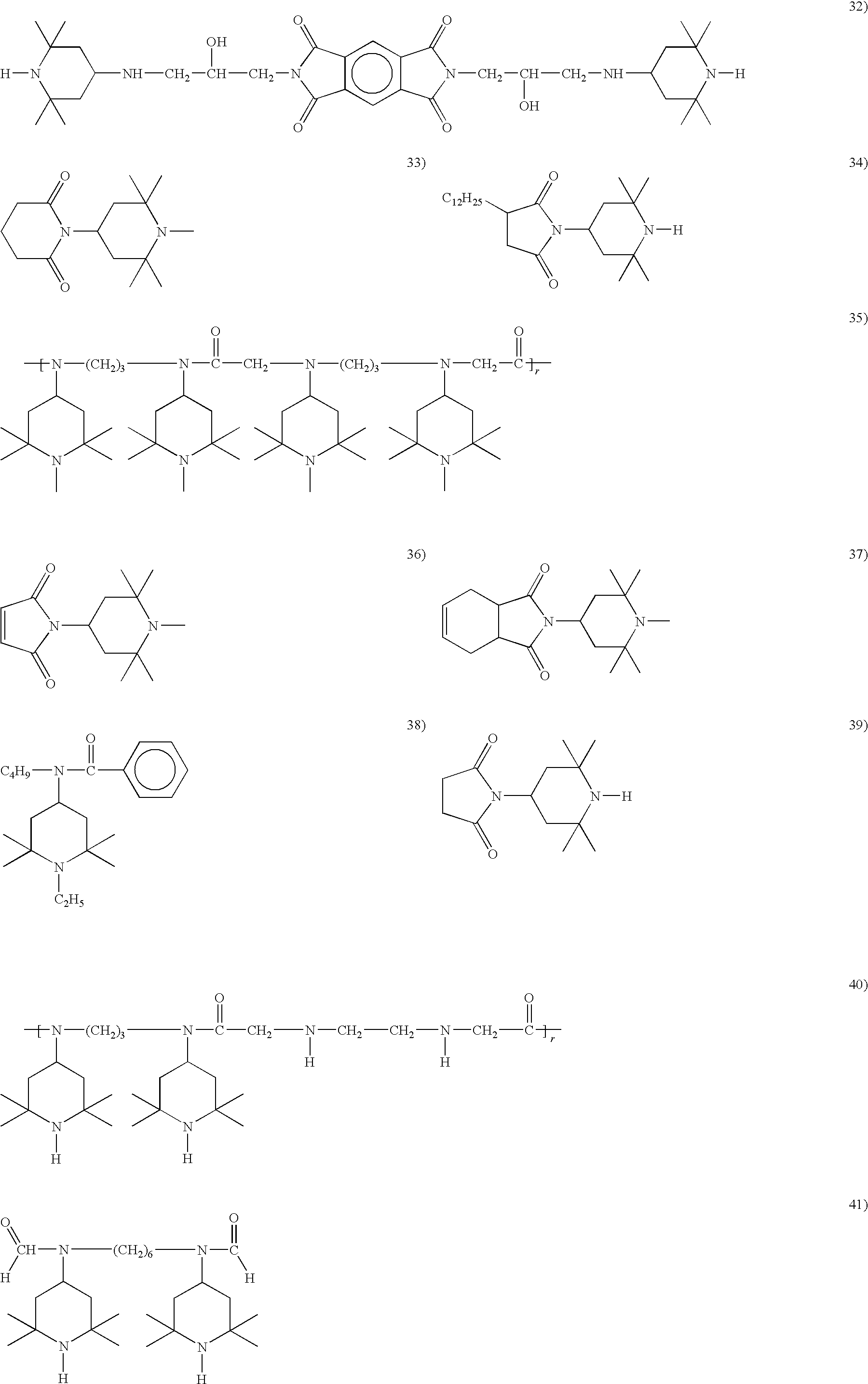

Compounds of the following structure are also suitable:

| | |
|---|---|
| | (D-3) |
| 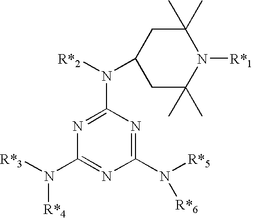 | |

| No. | 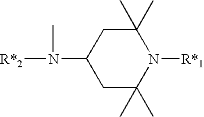 | 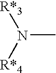 | 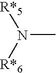 |
|---|---|---|---|
| 42) | PMP-NH— | H₂N— | H₂N— |
| 43) | TMP-NH— | TMP-NH— | H₂N— |
| 44) | TMP-NH— | Me₂N— | Me₂N— |
| 45) | TMP-NH— | TMP-NH— | TMP-NBu- |
| 46) | TMP-NH— | TMP-NH— | (HO—CH₂CH₂—)₂N— |
| 47) | TMP-NH— | (HO—CH₂CH₂—)NH— | TMP-NBu- |
| 48) | (TMP)₂-N— | H₂N— | H₂N— |
| 49) | TMP-NH— | 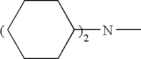 | 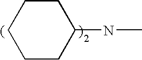 |
| 50) | (TMP)₂N— | (TMP)₂N— | (TMP)₂N— |
| 51) | PMP-NH— | PMP-NH— | PMP-NH— |
| 52) | (i-Pr)₂N—C₂H₄—N(TMP)- | Pr₂N— | Pr₂N— |
| 53) | (i-Pr)₂N—C₂H₄—N(TMP)- | TMP-NH | TMP-NH |
| 54) | TMP-NH— | Et₂N— | TMP-NH— |
| 55) | TMP-NH— | (HOCH₂)₃C—NH— | TMP-NH— |
| 56) | TMP-NH— | 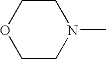 | Et₂N—C₂H₄—NH— |
| 57) | TMP₂N— | TMP-NH— | Et₂N—C₂H₄—NH— |
| 58) | TMP-NH— | TMP-NH— | 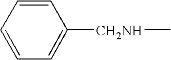 |
| 59) | TMP-NH— | 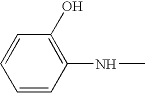 | TMP-NH— |
| 60) | TMP-NH— | 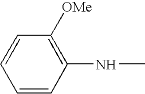 | 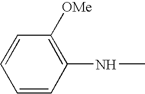 |
| 61) | TMP-NH— | Et₂N—C₂H₄—NH— | 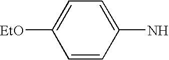 |
| 62) | TMP-N(nBu)- | Et₂N— | Et₂N— |
| 63) | TMP-N(Et)- | (n-Bu)₂N— | TMP-N(Et)- |
| 64) | TMP-NH— | 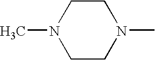 | TMP-NH— |
| 65) | TMP-NH— | 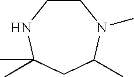 | TMP-NH— |
| 66) | 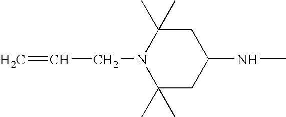 | 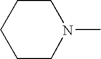 | 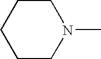 |
| 67) | 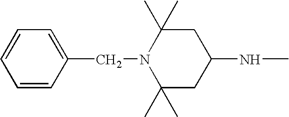 | 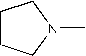 | 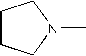 |
| 68) | 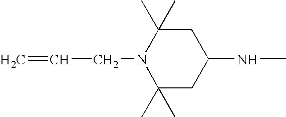 | TMP-NH— | TMP-NH— |
| 69) | TMP-NH— | (HO—C₂H₄)₂N— | (HO—C₂H₄)₂N— |
| 70) | 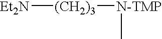 | TMP-NH— | TMP-NH— |
| 71) | 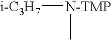 | PMP-NH— | PMP-NH— |
| 72) | 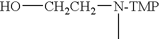 | 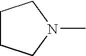 | 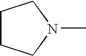 |
| 73) | 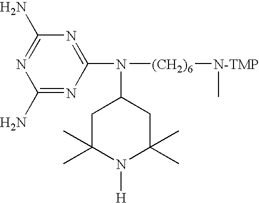 | H₂N— | H₂N— |
| 74) | 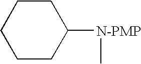 | TMP-NH— | TMP-NH— |
| 75) | 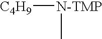 | 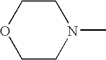 | 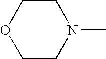 |
| 76) | 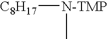 | TMP-NH— | TMP-NH— |
| 77) | 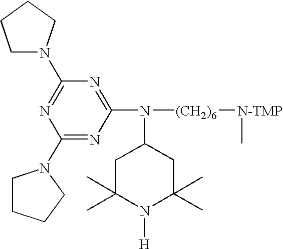 | 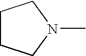 | 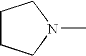 |
| 78) | 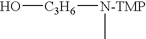 | TMP-NH— | TMP-NH— |
| 79) | 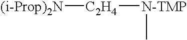 | (i-Pr)₂N—C₂H₄—NH— | (i-Pr)₂N—C₂H₄—NH— |
| 80) | 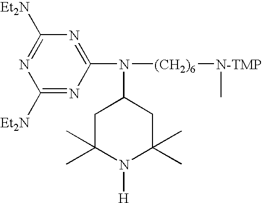 | Et₂N— | Et₂N— |
| 81) | 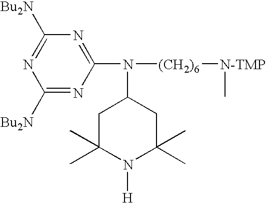 | Bu₂N— | Bu₂N— |
| 82) | 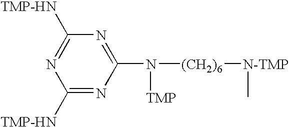 | TMP-NH— | TMP-NH— |
| 83) | 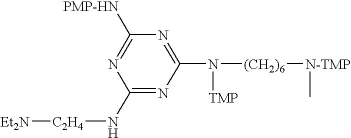 | TMP-NH— | Et₂N—C₂H₄—NH— |
| 84) | (TMP₂)N— | (i-Pr)₂N—C₂H₄—NH— | (i-Pr)₂N—C₂H₄—NH— |
| 85) | TMPNH— | Et₂N—C₂H₄—NH— | Et₂N—C₂H₄—NH— |
| 86) | 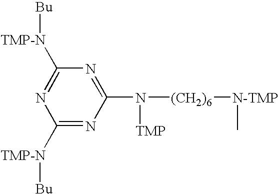 | TMP-N(nBu)- | TMP-N(nBu)- |

### Explanations:

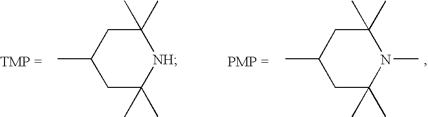

Me=methyl;
Et=ethyl; Pr=propyl; Bu=butyl.

Further suitable compounds are:

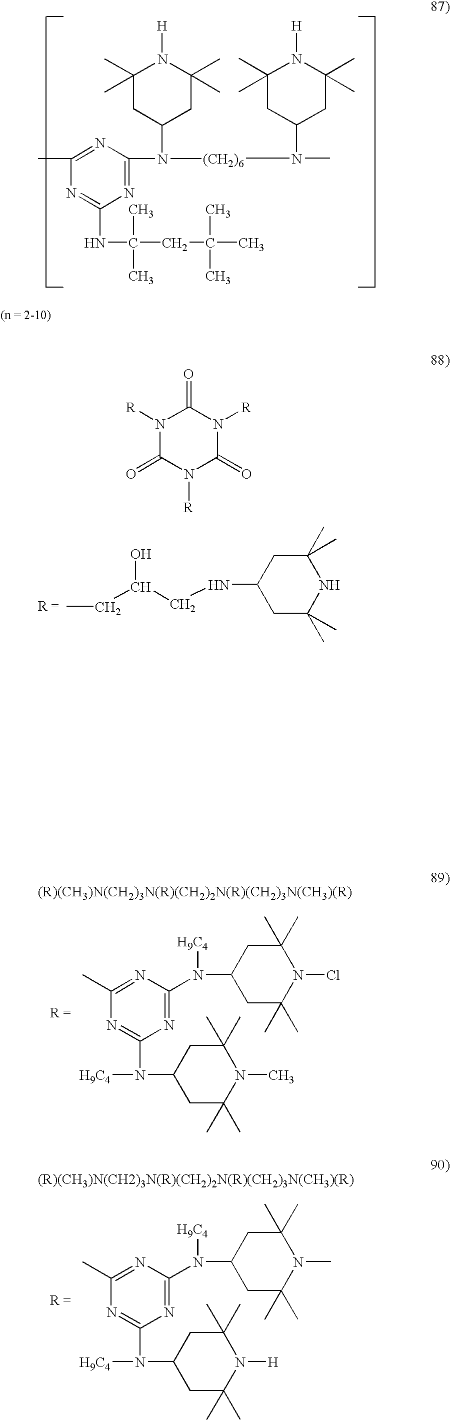

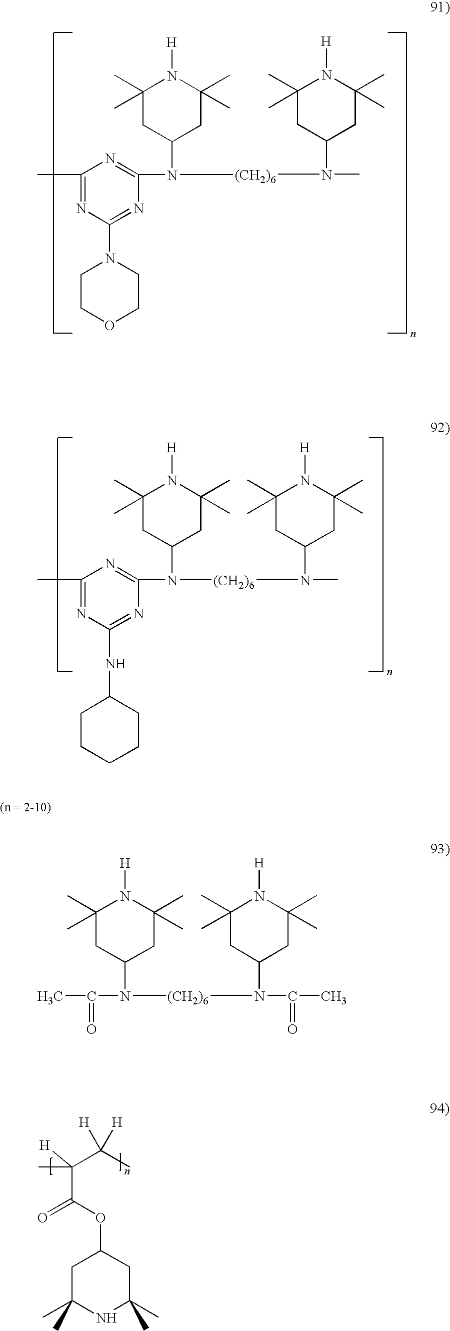

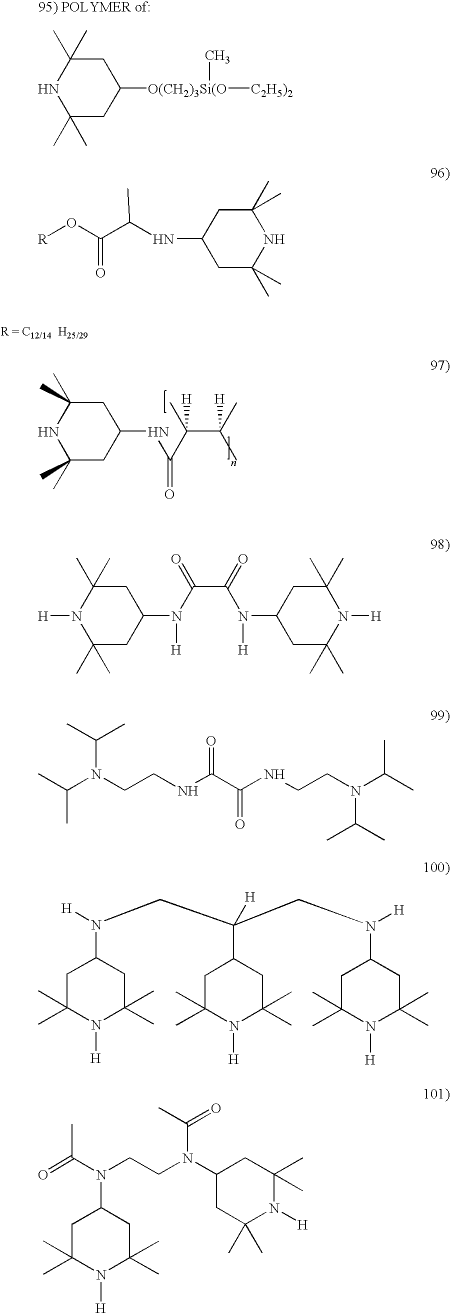

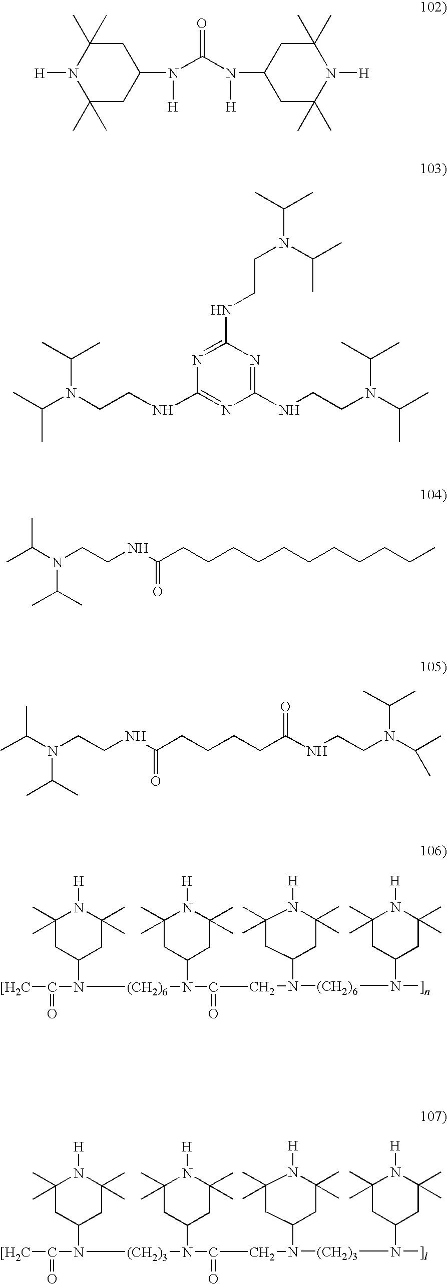

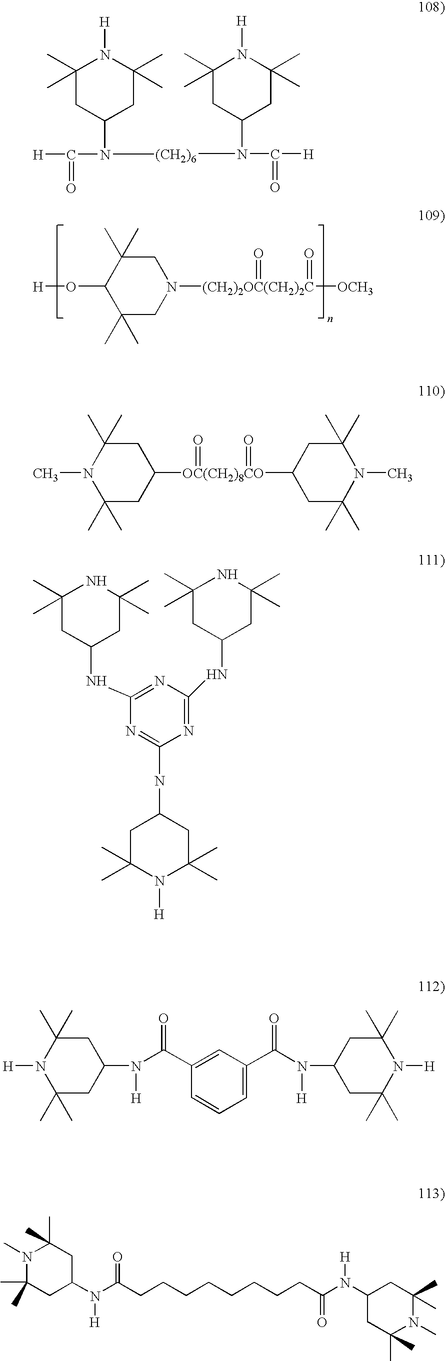

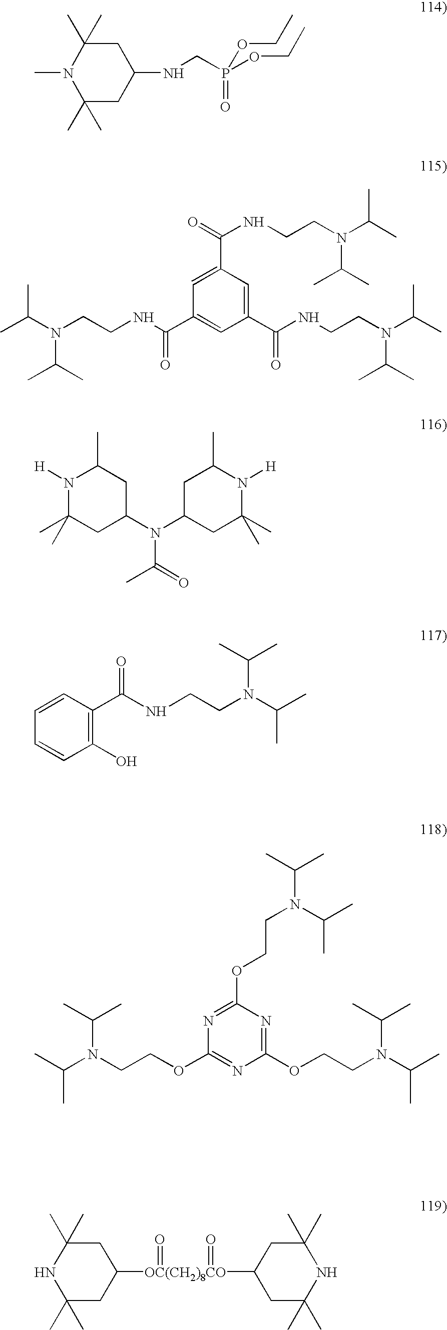

Further examples are:

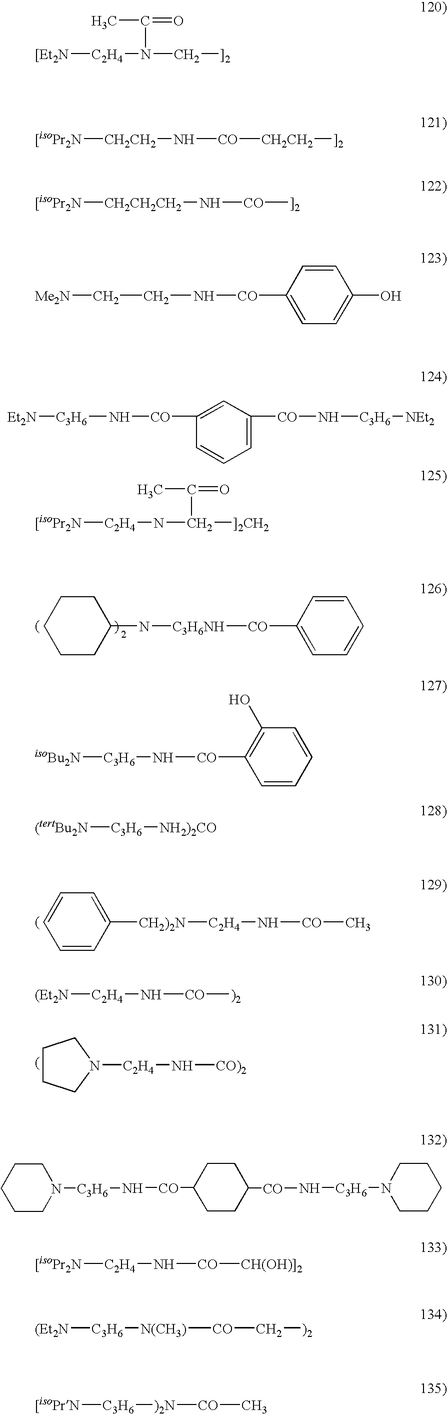

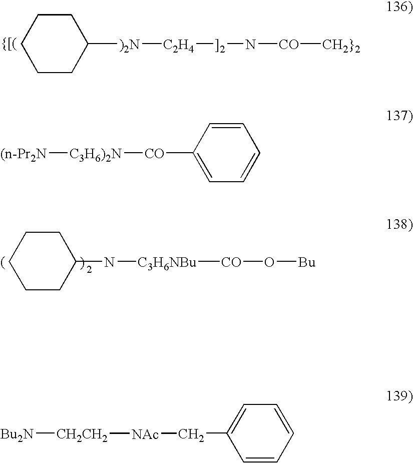

and compounds of the structure (D-4)

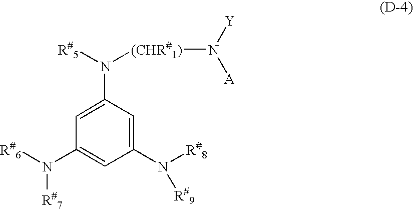

Examples of compounds of the formula (D-4) are:

| No. | AYN-CHR^{#}₁)ₘ-NR^{#}₅— | R^{#}₆R^{#}₇N— | R^{#}₈R^{#}₉N— |
|---|---|---|---|
| 140 | Et₂N—C₂H₄—NH— | —NH₂ | —NH₂ |
| 141 | Et₂N—C₂H₄—NH— | Et₂N—C₂H₄—NH— | Et₂N—C₂H₄—NH— |
| 142 | ⁿPr₂N—C₃H₆—NH— | HO—C₂H₄—NH— | HO—C₂H₄—NH— |
| 143 | ⁿPr₂N—C₂H₄—NH— | (HO—C₂H₄)₂N— | (HO—C₂H₄)₂N— |
| 144 | 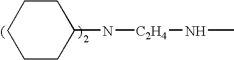 | Et-NH— | 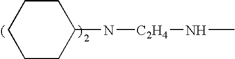 |
| 145 | 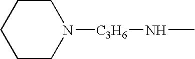 | 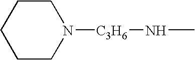 | 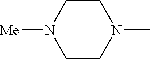 |
| 146 | 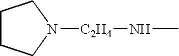 | 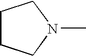 | 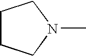 |
| 147 | 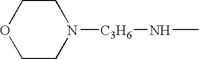 | 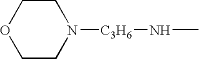 | 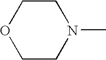 |
| 148 | ^{iso}Pr₂N—C₂H₄—NH— | ^{iso}Pr₂N—C₂H₄—NH— | ^{iso}Pr₂N— |
| 149 | ^{iso}Pr₂N—C₂H₄—NH— | ^{iso}Pr₂N—C₂H₄—NH— | ^{iso}PrNEt- |
| 150 | Et₂N—C₂H₄—NH— | Et₂N—C₂H₄—NH— | 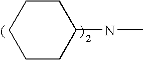 |

Me is methyl, Bu is butyl, ^{tert}Bu is tert-butyl, ^{iso}Pr is isopropyl, ⁿPr is normal propyl, Ac is acetyl

The compounds 1, 1a, 1b, 3, 4, 6, 9, 16, 41, 87, 88, 91, 92, 93, 103, 106 and 111 are preferred. 1, 1b, 2, 6, 9, 16, 41, 87, 88, 92, 93, 103 and 111 are particularly preferred.

41, 87, 93 and 103 are very particularly preferred.

The compounds of component (D) are used for stabilization in the chlorine-containing polymer expediently in an amount of from 0.01 to 10, preferably from 0.05 to 5, in particular from 0.1 to 3, parts per 100 parts of polymer.

Instead of an individual sterically hindered amine, it is also possible for the purposes of the present invention to use a mixture of different sterically hindered amines.

Said amines are frequently known compounds; many of them are commercially available. The compounds may be present in the polymer in an amount of from 0.005 to 5, preferably from 0.01 to 2 and in particular from 0.01 to 1%.

The combinations of (D) with 6-iminobarbituric acids (A-1) and cyanamides or cyanamide derivatives (B-2) are particularly preferred here.

The combinations of (D) with N,N′-dimethyl-6-iminobarbituric acid [21]+dicyandiamide [187] are very particularly preferred.

Furthermore, one or more tertiary ethanolamines (E) of the formulae (E-1) or (E-2) can be added to the two-component (A+B) or three-component (A+B+C) combinations.

R¹—NR²—CH₂—CHOH—R¹ (E-1)

Q-CH₂—CHOH—R¹ (E-2)

in which Q is a 4- to 8-membered ring system which may be interrupted by one or two X atoms or NR¹ groups and in which X, R¹ and R² independently have the above-mentioned meaning.

6-Aminobarbituric acids are preferred as the (A-1) component, or bisaminocrotonic acid esters as the (A-2) components, dicyandiamide is preferred as the (B-2) component, sodium or potassium perchlorate is preferred as the (C-1) component, and triethanolamine (TEA), triisopropanolamine (TIPA), triisobutanolamine (TIBA), bisethanol(isopropanol, isobutanol) fatty amine or a mono adduct of a diethanolamine=DEA (isopropanol=DIPA, isobutanol=DIBA) amine with an alkene oxide or a diadduct of a monoethanol=MEA (isopropanol=MIPA, isobutanol=MIBA) amine with an alkene oxide is preferred as component (E).

TEA, TIPA and TIBA and DEA adducts, DIPA adducts and DIBA adducts or MEA adducts, MIPA adducts and MIBA adducts with alkene oxides are particularly preferred here.

Very particularly preferred is the combination: N,N′-dimethyl-6-iminobarbituric acid+dicyandiamide+sodium perchlorate with TEA or with TIPA.

The substances of category (E) are to be used in the chlorine-containing polymer expediently in an amount of from 0.01 to 10 phr, preferably from 0.05 to 5 phr and in particular from 0.1 to 2.0 phr.

These novel stabilizer systems, for example based on the combinations (A-1)/(B-1), (B-2) or (A-2)/(B-1), (B-2), are particularly suitable for stabilizing chlorine-containing polymers, in particular PVC. The prestabilization means that a reduced amount of heat stabilizers has to be added to the polymer during the processing, since said polymer now has less preliminary damage, said heat stabilizers being added either in the form of conventional stabilizers, such as organotin compounds or Ba/Zn or Ca/Zn fatty acid carboxylates or generally metal salts, or in the form of completely novel and completely heavy metal-free stabilizer types having an organic basis. This procedure may mean a capital savings and protects resources, i.e. may be classed as being particularly advantageous from economic and environmentally friendly points of view.

Preferably, stabilizer systems are suitable for rigid or flexible PVC, or suspension or emulsion PVC, in particular if they are premixed in the presence of PVC.

Furthermore, stabilizers or additives may be added to the combinations according to the invention.

The invention furthermore preferably relates in particular to mixtures of at least one stabilizer component (A-1) or (A-2) with at least one further cocomponent (B-1) or (B-2) or (A-1) with (B-1) or (B-2) and (A-2) with (B-1) and (C) or (A-2) with (B-2) and (C), to which optionally an additional cocomponent (C) and/or (D) and/or (E) is added, with at least one further customary stabilizer or additive.

Phosphites, polyols and disaccharide alcohols, β-diketones, thiophosphites and thiophosphates, mercaptocarboxylic acid esters, dihydropyridines, hydrotalcites, zeolites (alkali metal or alkaline earth metal aluminum silicates), metal soaps, zinc compounds, alkali metal and alkaline earth metal compounds, epoxidized fatty acid esters and other epoxide compounds, hydroxycarboxylate metal salts, fillers, lubricants, plasticizers, pigments, antioxidants, UV absorbers, light stabilizers, optical brighteners, blowing agents, antistatic agents, biocides (antimicrobial agents), antifogging agents, impact modifiers, processing auxiliaries, gelling agents, flameproofing agents, metal deactivators and compatibilizers are preferred as a further group of components.

Further additives, such as adhesives, calendering aids, release agents, mold release agents, lubricants and fragrances and colorants may also be present. Examples of such additional components are mentioned and explained further below (cf. “Handbook of PVC Formulating” by E. J. Wickson, John Wiley & Sons, New York 1993).

Epoxidized fatty acid esters and other epoxide compounds and polyols, alkaline earth metal and aluminum soaps and magnesium, calcium and aluminum hydroxides, zeolites, hydrotalcites and phosphites are particularly preferred as a further type of component. Phosphites, disaccharide alcohols, dehydrated hydrotalcites and zeolites and calcium and magnesium hydroxide or calcium stearate or basic magnesium, calcium or aluminum salts or “Overbased” compounds of magnesium and of calcium are very particularly preferred.

### Phosphites

Organic phosphites are known costabilizers for chlorine-containing polymers. Examples are trioctyl, tridecyl, tridodecyl, tritridecyl, tripentadecyl, trioleyl, tristearyl, triphenyl, trilauryl, tricresyl, trisnonylphenyl, tris-2,4-tert-butylphenyl or tricyclohexyl phosphite. Further suitable phosphites are mixed aryl dialkyl or alkyl diaryl phosphites having different radicals, such as phenyl dioctyl, phenyl didecyl, phenyl didodecyl, phenyl ditridecyl, phenyl ditetradecyl, phenyl dipentadecyl, octyl diphenyl, decyl diphenyl, undecyl diphenyl, dodecyl diphenyl, tridecyl diphenyl, tetradecyl diphenyl, pentadecyl diphenyl, oleyl diphenyl, stearyl diphenyl and dodecyl bis-2,4-di-tert-butylphenyl phosphite. Furthermore, phosphites of different di- or polyols can also advantageously be used, e.g. tetraphenyl dipropylene glycol diphosphite, poly(dipropylene glycol) phenyl phosphite, tetraisodecyl dipropylene glycol diphosphite, trisdipropylene glycol phosphite, tetramethylolcyclohexanol decyl diphosphite, tetramethylolcyclohexanol butoxyethoxyethyl diphosphite, tetramethylolcyclohexanol nonylphenyl diphosphite, bisnonylphenyl ditrimethylolpropane diphosphite, bis-2-butoxyethyl ditrimethylolpropane diphosphite, trishydroxyethyl isocyanurate hexadecyl triphosphite, didecyl pentaerythrityl diphosphite, distearyl pentaerythrityl diphosphite, bis-2,4-di-tert-butylphenyl pentaerythrityl diphosphite, and mixtures of these phosphites and aryl/alkyl phosphite mixtures of the random composition (H₁₉C₉-C₆H₄)O_{1,5}P(OC₁₂₋₁₃H_{25,27})_{1,5} or (C₈H₁₇—C₆H₄—O—)₂P(i-C₈H₁₇O),(H₁₉C₉-C₆H₄)O_{1,5}P(OC₉₋₁₁H_{19,23})_{1,5}. Industrial examples are Naugard P, Mark CH300, Mark CH301, Mark CH302 and Mark CH55 (manufacturer Crompton Corp. USA). The organic phosphites can be used in an amount of, for example, from 0.01 to 10, expediently from 0.05 to 5 and in particular from 0.1 to 3 parts by weight, based on 100 parts by weight of PVC.

### Polyols and Sugar Alcohols

For example, the following are suitable as compounds of this type: pentaerythritol, dipentaerythritol, tripentaerythritol, trimethylolethane, bistrimethylolpropane, inositol, polyvinyl alcohol, bistrimethylolethane, trimethylolpropane, sorbitol, maltitol, isomaltitol, lycasin, mannitol, lactose, leucrose, tris(hydroxyethyl)isocyanurate, palatinitol, tetramethylcyclohexanol, tetramethylolcyclopentanol, tetramethylolpyranol, glycerol, diglycerol, polyglycerol, thiodiglycerol or 1-O-∝-D-glycopyranosyl-D-mannitol dihydrate. Disaccharide alcohols are preferred. Polyol syrups, such as sorbitol, mannitol and maltitol syrup, are also used. The polyols can be used in an amount of, for example, from 0.01 to 20, expediently from 0.1 to 20 and in particular from 0.1 to 10 parts by weight, based on 100 parts by weight of PVC.

### β-Diketones

1,3-Dicarbonyl compounds which can be used are linear or cyclic dicarbonyl compounds. Preferably used dicarbonyl compounds are those of the formula R′₁COCHR₂—COR′₃, in which R′₁ is C₁-C₂₂-alkyl, C₅-C₁₀-hydroxyalkyl, C₂-C₁₈-alkenyl, phenyl, phenyl substituted by OH, C₁-C₄-alkyl, C₁-C₄-alkoxy or halogen, C₇-C₁₀-phenylalkyl, C₅-C₁₂-cycloalkyl, C₅-C₁₂-cycloalkyl substituted by C₁-C₄-alkyl, or a group —R₁₅—S—R₁₆ or —R₁₅—O—R₁₆; R₁₂ is hydrogen, C₁-C₈-alkyl, C₂-C₁₂-alkenyl, phenyl, C₇-C₁₂-alkylphenyl, C₇-C₁₀-phenylalkyl or a group —CO—R₁₄; R₁₃ has one of the meanings given for R′₁ or is C₁-C₁₈-alkoxy; R′₄ is C₁-C₄-alkyl or phenyl; R′₅ is C₁-C₁₀-alkylene and R′₆ is C₁-C₁₂-alkyl, phenyl, C₇-C₁₈-alkylphenyl or C₇-C₁₀-phenylalkyl.

These include the diketones of EP 0,346,279 A1 which contain hydroxyl groups and the oxa- and thiadiketones of EP 0,307,358 A1 as well as the ketoesters of U.S. Pat. No. 4,339,383 which are based on isocyanic acid.

R′₁ and R₁₃ as alkyl may be in particular C₁-C₁₈-alkyl, e.g. methyl, ethyl, n-propyl, isopropyl, n-butyl, tert-butyl, pentyl, hexyl, heptyl, octyl, decyl, dodecyl or octadecyl.

R′₁ and R′₃ as hydroxyalkyl are in particular a —(CH₂)ₙ—OH group, in which n is 5, 6 or 7.

R′₁ and R′₂ as alkenyl may be, for example, vinyl, allyl, methallyl, 1-butenyl, 1-hexenyl or oleyl, preferably allyl.

R′¹ and R′₃ as phenyl substituted by OH, alkyl, alkoxy or halogen may be, for example, tolyl, xylyl, tert-butylphenyl, methoxyphenyl, ethoxyphenyl, hydroxyphenyl, chlorophenyl or dichlorophenyl.

R′₁ and R′₃ as phenylalkyl are in particular benzyl. R′₂ and R′₃ as cycloalkyl or alkylcycloalkyl are in particular cyclohexyl or methylcyclohexyl.

R′₂ as alkyl may be in particular C₁-C₄-alkyl. R′₂ as C₂-C₁₂-alkenyl may be in particular allyl. R′₂ as alkylphenyl may be in particular tolyl. R′₂ as phenylalkyl may be in particular benzyl. R′₂ is preferably hydrogen. R′₃ as alkoxy may be, for example, methoxy, ethoxy, butoxy, hexyloxy, octyloxy, dodecyloxy, tridecyloxy, tetradecyloxy or octadecyloxy. R′₅ as C₁-C₁₀-alkylene is in particular C₂-C₄-alkylene. R′₆ as alkyl is in particular C₄-C₁₂-alkyl, e.g. butyl, hexyl, octyl, decyl or dodecyl.

R′₆ as alkylphenyl is in particular tolyl. R′₆ as phenylalkyl is in particular benzyl.

Examples of 1,3-dicarbonyl compounds of the above general formula and the alkali metal, alkaline earth metal and zinc chelates thereof are acetylacetone, butanoylacetone, heptanoylacetone, stearoylacetone, palmitoylacetone, lauroylacetone, 7-tert-nonylthio-heptane-2,4-dione, benzoylacetone, dibenzoylmethane, lauroylbenzoylmethane, palmitoyl-benzoylmethane, stearoylbenzoylmethane, isooctylbenzoylmethane, 5-hydroxy-caproylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoyl-methane, bis(4-methoxybenzoyl)methane, 1-benzoyl-1-acetylnonane, benzoylacetyl-phenylmethane, stearoyl-4-methoxybenzoylmethane, bis(4-tert-butylbenzoyl)methane, benzoylformylmethane, benzoylphenylacetylmethane, biscyclohexanoylmethane, dipivaloylmethane, 2-acetylcyclopentanone, 2-benzoylcyclopentanone, methyl, ethyl and allyl diacetate, methyl and ethyl benzoyl-, propionyl- and butyryl acetate, triacetylmethane, methyl, ethyl, hexyl, octyl, dodecyl or octadecyl acetate, methyl, ethyl, butyl, 2-ethylhexyl, dodecyl or octadecyl benzoyl acetate, and C₁-C₁₈-alkyl propionyl- and butyryl acetate. Ethyl, propyl, butyl, hexyl or octyl stearoyl acetate and polynuclear β-ketoesters as described in EP-A 0 433 230 and dehydracetic acid and the zinc, magnesium or alkali metal salts thereof. Calcium, magnesium and zinc salts of acetylacetone and of dehydracetic acid are preferred.

Particularly preferred are 1,3-diketo compounds of the above formula, in which R′₁ is C₁-C₁₈-alkyl, phenyl, phenyl substituted by OH, methyl or methoxy, C₇-C₁₀-phenylalkyl or cyclohexyl, R′₂ is hydrogen and R′₃ has one of the meanings given for R′¹. Also included are heterocyclic 2,4-diones, such as N-phenyl-3-acetylpyrrolidine-2,4-dione. Further members of this category are described in EP 0.734.414 A1. The 1,3-diketo compounds can be used in an amount of, for example, from 0.01 to 10, expediently from 0.01 to 3 and in particular from 0.01 to 2 parts by weight, based on 100 parts by weight of PVC.

### Thiophosphites and Thiophosphates

Thiophosphites and thiophosphates are to be understood as meaning compounds of the general type (RS)₃P, (RS)₃P═O and (RS)₃P═S, respectively, as described in the publications DE 28 09 492 A1, EP 0,090,770 A1 and EP 0,573,394 A1. Examples of these compounds are trithiohexyl phosphite, trithiooctyl phosphite, trithiolauryl phosphite, trithiobenzyl phosphite, tris(carboisooctyloxy)methyl trithiophosphate, tris(carbotrimethylcyclohexyloxy)methyl trithiophosphate, S,S,S-tris(carboisooctyloxy)methyl trithiophosphate, S,S,S-tris(carbo-2-ethylhexyloxy)methyl trithiophosphate, S,S,S-tris-1-(carbohexyloxy)ethyl trithiophosphate, S,S,S-tris-1-(carbo-2-ethylhexyloxy)ethyl trithiophosphate and S,S,S-tris-2-(carbo-2-ethylhexyloxy)ethyl trithiophosphate.

### Mercaptocarboxylic Acid Esters

Examples of these compounds are esters of thioglycolic acid, thiomalic acid, mercapto-propionic acid, of mercaptobenzoic acids or of thiolactic acid, mercaptoethyl stearate and oleate, as described in the publications FR-A 2,459,816, EP 0,090,748 A1, FR-A 2,552,440, EP 0,365,483 A1. The mercaptocarboxylic acid esters also comprise polyol esters and the partial esters thereof.

### Dihydropyridines

Suitable monomeric dihydropyridines are compounds as described in FR-A 2,039,496, EP 0,002,007 A1, EP 0,362,012 A1 and EP 0,240,754 A1. Those of the formula

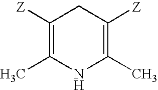

in which Z is CO₂CH₃, CO₂C₂H₅, CO₂ⁿCl₂H₂₅ or CO₂C₂H₄—S—ⁿC₁₂H₂₅, are preferred.

Particularly suitable polydihydropyridines are compounds of the following formula

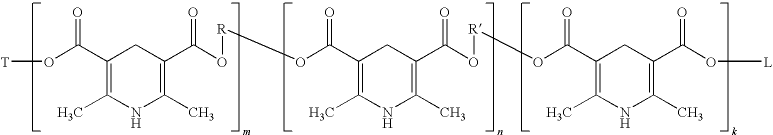

in which T is unsubstituted C₁₋₁₂-alkyl, L has the same meaning as T, m and n are numbers from 0 to 20, k is 0 or 1, R and R′, independently of one another, are ethylene, propylene, butylene or an alkylene- or cycloalkylenebismethylene group of the type —(CₚH₂ₚ—X—)ₜCₚH₂ₚ—, p is 2 to 8, t is 0 to 10 and X is oxygen or sulfur.

Such compounds are described in more detail in EP 0,286,887 A1. The (poly)dihydropyridines can be used in the chlorine-containing polymer expediently in an amount of from 0.001 to 5 parts and in particular from 0.005 to 1 part by weight, based on the polymer. Thiodiethylene bis(5-methoxycarbonyl-2,6-dimethyl-1,4-dihydropyridine-3-carboxylate) is particularly preferred.

### Hydrotalcites

The chemical composition of these compounds is known to the person skilled in the art, for example from the publications DE 38 43 581 A1, U.S. Pat. No. 4,000,100, EP 0,062,813 A1 and WO 93/20135. These may be based on Al/Mg/carbonate, Al/Mg/Ti/carbonate, Li/Mg/carbonate or Li/Al/Mg/carbonate, as described in DE 102 17 364 A1 (Süd Chemie), DE 44 252 66 A1 (Metallgesellschaft), EP 0,549,340 A1 (Mizusawa Ind. Chem.) and EP 0,761,756 A1 (Fuji Chem. Ind.). Compounds from the series consisting of the hydrotalcites can be described by the following general formula

M²⁺₁₋ₓM³⁺ₓ(OH)₂(Aⁿ)_{x/b}.dH₂O

in which
M²⁺=is a cation of one or more metals from the group consisting of Mg, Ca, Sr, Zn or Sn, M³⁺ is an Al or B cation, Aⁿ is an anion having a valency −n, b=n is a number 1-2, 0≦x≦0.5, d is a number 0-20. Compounds having Aⁿ=OH⁻, ClO₄⁻, HCO₃⁻, CH₃COO⁻, C₆H₅COO⁻, CO₃²⁻, (CHOHCOO)₂²⁻, (CH₂COO)₂²⁻, CH₃CHOHCOO⁻, HPO₃⁻ or HPO₄²⁻ are preferred.

Examples of hydrotalcites are

### Al₂O₃.6MgO.CO₂.12H₂O, Mg_{4,5}Al₂(OH)₁₃.CO₃.3,5H₂O,

4MgO.Al₂O₃.CO₂.9H₂O, 4MgO.Al₂O₃.CO₂.6H₂O, ZnO.3MgO.Al₂O₃.CO₂.8-9H₂O and ZnO.3MgO.Al₂O₃.CO₂.5-6H₂O.

Particularly preferred are the types Alkamizer 1 and 2, Alkamizer P 93-2 (manufacturer Kyowa Chemical Ind. Co., Japan) and L-CAM (lithium-modified hydrotalcite=Lithium/Carbonate/Aluminum/Magnesium, manufacturer Fuji Chem. Ind. Co. Ltd., Japan and Metallgesellschaft AG, Germany). Dehydrated hydrotalcites are very particularly preferably used.

### Zeolites (Alkali Metal or Alkaline Earth Metal Aluminosilicates)

They can be described by the formula M_{x/n}[(AlO₂)ₓ(SiO₂)_{y}].wH₂O, in which n is the charge of the cation M; M is an element of the first or second main group, such as Li, Na, K or NH₄ and Mg, Ca, Sr or Ba; y:x is a number from 0.8 to 15, preferably from 0.8 to 1.2; and w is a number from 0 to 300, preferably from 0.5 to 30. Examples of zeolites are sodium aluminosilicates of the formulae Na₁₂Al₁₂Si₁₂O₄₈ 27H₂O [zeolite A], Na₆Al₆Si₆O₂₄.2NaX.7.5H₂O, X═OH, halogen, ClO₄ [sodalite]; Na₆Al₆Si₃₀O₇₂ 24H₂O; Na₈Al₈Si₄₀O₉₆ 24H₂O; Na₁₆Al₁₆Si₂₄O₈₀ 16H₂O; Na₁₆Al₁₆Si₃₂O₉₆ 16H₂O; Na₅₆Al₅₆Si₁₃₆O₃₈₄ 250H₂O [zeolite Y], Na₈₆Al₅₆Si₁₀₆O₃₈₄ 264H₂O [zeolite X]; Na₂O, Al₂O₃, (2-5)SIO₂, (3,5-10)H₂O[zeolite P]; Na₂O, AL₂O₃, 2SiO₂, (3,5-10)H₂O(zeolite MAP); or the zeolites which can be prepared by partial or complete exchange of the Na atoms for Li, K, Mg, Ca, Sr or Zn atoms, such as (Na,K)₁₀Al₁₀Si₂₂O₆₄.20H₂O; Ca_{4,5}Na₃[(AlO₂)₁₂(SiO₂)₁₂] 30H₂O; K₉Na₃[(AlO₂)₁₂(SiO₂)₁₂] 27H₂O, Na zeolite A and Na zeolite MAP (see also U.S. Pat. No. 6,531,533) are very particularly preferred. Zeolites having an extremely small particle size, in particular are the Na-A and Na—P type, as also described in U.S. Pat. No. 6,096,820, are likewise preferred.

The hydrotalcites and/or zeolites can be used in amounts of, for example, from 0.1 to 20, expediently from 0.1 to 10 and in particular from 0.1 to 5 parts by weight, based on 100 parts by weight of halogen-containing polymer.

### Epoxidized Fatty Acid Esters and Other Epoxide Compounds

The stabilizer combination according to the invention may additionally preferably comprise at least one epoxidized fatty acid ester. In particular, esters of fatty acids from natural sources (fatty acid glycerides), such as soybean oil or rapeseed oil, are suitable for this purpose. However, it is also possible to use synthetic products, such as epoxidized butyl oleate. Epoxidized polybutadiene and polyisoprene, optionally also in partially hydroxylated form, or glycidyl acrylate and glycidyl methacrylate as homo- or copolymers can also be used. These epoxy compounds can also be applied to an alumino salt compound; cf. in this context also DE 4,031,818 A1.

### Metal Soaps

Metal soaps are mainly metal carboxylates, preferably of relatively long-chain carboxylic acids. Familiar examples are stearates and laurates, and also oleates and salts of shorter-chain aliphatic or aromatic carboxylic acids, such as acetic acid, propionic acid, butyric acid, valeric acid, hexanoic acid, sorbic acid, oxalic acid, malonic acid, succinic acid, glutaric acid, adipic acid, fumaric acid, citric acid, benzoic acid, salicylic acid, phthalic acids, hemimellitic acid, trimellitic acid, pyromellitic acid.

The following may be mentioned as metals: Li, Na, K, Mg, Ca, Sr, Ba, Zn, Al, La, Ce and rare earth metals. So-called synergistic mixtures, such as barium/zinc, magnesium/zinc, calcium/zinc or calcium/magnesium/zinc stabilizers, are often used. The metal soaps may be used individually or as mixtures. An overview of customary metal soaps is to be found in Ullmann's Encyclopedia of Industrial Chemistry, 5^{th} Ed., Vol. A16 (1985), page 361 et seq.). Magnesium, potassium and zinc soaps are preferred.

### Zinc Compounds:

The organic zinc compounds having a Zn—O bond are zinc enolates, zinc phenolates and/or zinc carboxylates. The latter are compounds from the series consisting of the aliphatic saturated and unsaturated C₁₋₂₂-carboxylates, the aliphatic saturated or unsaturated C₂₋₂₂-carboxylates which are substituted by at least one OH group and whose chain is interrupted by one or more O atoms (oxa acids), the cyclic and bicyclic carboxylates having 5-22 carbon atoms, the phenyl carboxylates which are unsubstituted, substituted by at least one OH group and/or C₁₋₁₆-alkyl-substituted, the phenyl C₁₋₁₆-alkylcarboxylates or the phenolates optionally substituted by C₁₋₁₂-alkyl, or abietic acid. Zn—S compounds are, for example, zinc mercaptides, zinc mercaptocarboxylates and zinc mercaptocarboxylic acid esters.

As examples, the zinc salts of the monovalent carboxylic acids, such as formic acid, acetic acid, propionic acid, butyric acid, valeric acid, hexanoic acid, enanthic acid, octanoic acid, neodecanoic acid, 2-ethylhexanoic acid, perlargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, ricinoleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid and sorbic acid, cinnamic acid, mandelic acid, glycolic acid; zinc salts of the divalent carboxylic acids or of the monoesters thereof, such as oxalic acid, malonic acid, succinic acid, glutaric acid, adipic acid, fumaric acid, pentane-1,5-dicarboxylic acid, hexane-1,6-dicarboxylic acid, heptane-1,7-dicarboxylic acid, octane-1,8-dicarboxylic acid, 3,6,9-trioxadecane-1,10-dicarboxylic acid, lactic acid, malonic acid, maleic acid, tartaric acid, malic acid, salicylic acid, polyglycoldicarboxylic acid (n=10-12), phthalic acid, isophthalic acid, terephthalic acid and hydroxyphthalic acid; and the di- or triesters of the tri- or tetravalent carboxylic acids, such as hemimellitic acid, trimellitic acid, pyromellitic acid, citric acid and furthermore so-called overbased zinc carboxylates or zinc lauryl mercaptide, zinc thioglycolate, zinc thiosalicylate, zinc bisisooctylthio-glycolate, zinc mercaptopropionate, zinc thiolactate, zinc thiomalate, zinc bisoctylmercaptopropionate, zinc bisisooctylthiolactate and zinc bislaurylthiomalate may be mentioned by name.

The zinc enolates are preferably enolates of acetylacetacetone, of benzoylacetacetone and of dibenzoylmethane and enolates of acetacetic and benzoylacetic esters and of dehydracetic acid. In addition, inorganic zinc compounds, such as zinc oxide, zinc hydroxide, zinc carbonate, basic zinc carbonate or zinc sulfide, can also be used.

Neutral or basic zinc carboxylates of a carboxylic acid having 1 to 22 carbon atoms (zinc soaps), such as, for example, benzoates or alkanoates, preferably C₈-alkanoates, stearate, oleate, laurate, palmitate, behenate, versatate, hydroxystearates and hydroxyoleates, dihydroxystearates, p-tert-butylbenzoate or (iso)octanoate, are preferred. Stearate, oleate, versatate, benzoate, p-tert-butylbenzoate and 2-ethylhexanoate are particularly preferred. The metal soaps or mixtures thereof can be used in an amount of, for example, from 0.001 to 10 parts by weight, expediently from 0.01 to 8 parts by weight, particularly preferably from 0.05 to 5 parts by weight, based on 100 parts by weight of PVC.

### Alkali Metal and Alkaline Earth Metal Compounds

These are understood as meaning chiefly the carboxylates of the acids described above, but also corresponding oxides or hydroxides or carbonates. Mixtures thereof with organic acids are also suitable. Examples are LiOH, NaOH, KOH, CaO, Ca(OH₂), MgO, Mg(OH)₂, Sr(OH)₂, Al(OH)₃, CaCO₃ and MgCO₃ (also basic carbonates, such as, for example, magnesia, alba and huntite), and fatty acid Na and K salts. In the case of alkaline earth metal and zinc carboxylates, it is also possible to use the adducts thereof with MO or M(OH)₂ (M=Ca, Mg, Sr or Zn), so-called “overbased” compounds. Alkali metal, alkaline earth metal and/or aluminum carboxylates are preferably used in addition to the stabilizers according to the invention.

### Hydroxycarboxylate Metal Salts

Hydroxycarboxylate metal salts may be furthermore be present, it being possible for the metal to be an alkali metal or alkaline earth metal or aluminum. Sodium, potassium, magnesium and calcium are preferred. The hydroxycarboxylic acid may be glycolic, lactic, malic, tartaric or citric acid or salicylic 4-hydroxybenzoic acid or glyceric, gluconic and sugar acid (cf. for example GB 1,694,873 and EP 303,564 A1).

### Hydrocalumites and Catoites

These calcium aluminum hydroxo salts have the composition Ca₂Al(OH)₆X₁/Ca₃Al(OH)₈× or Ca₃Al₂(OH)₁₀X₂ where X is preferably ═OH, ClO₄, HPO₃ and HCO₃. These layer lattice compounds are present in hydrated form.

Furthermore, other layer lattice compounds, such as Al(OH)₃ and lithium hydrotalcite, can be used. Further statements in this context are to be found in EP 0,930,332 A1. The synthesis of L-CAM perchlorate is described, for example, in EP 0,761,756 A1.

### Fillers

For example, calcium carbonate, dolomite, wollastonite, magnesium oxide, magnesium hydroxide, silicates, China clay, talc, glass fibers, glass beads, wood flour, mica, metal oxides or metal hydroxides, carbon black, graphite, crushed rock, barite, glass fibers, talc, kaolin and chalk are used. Chalk (including coated chalk) is preferred (HANDBOOK OF PVC FORMULATING, E. J. Wickson, John Wiley & Sons, 1993, pages 393-449) and reinforcing agents (TASCHENBUCH DER KUNSTSTOFFADDITIVE [POCKETBOOK OF PLASTICS ADDITIVES], R. Gächter & H. Müller, Carl Hanser, 1990, pages 549-615).

The fillers can be used in an amount of, preferably, at least one part, for example from 5 to 200, expediently from 5 to 150 and in particular from 5 to 100 parts by weight, based on 100 parts by weight of PVC.

### Lubricants

Examples of suitable lubricants are: montan waxes, fatty acid esters, PE and PP waxes, amide waxes, chloroparaffins, glyceryl esters or alkaline earth metal soaps, and furthermore fatty ketones and combinations thereof, as mentioned in EP 0,259,783 A1. Calcium stearate is preferred.

### Plasticizers

Suitable organic plasticizers are, for example, those from the following groups:

(i) phthalic acid esters, such as, preferably, di-2-ethylhexyl, diisononyl and diisodecyl phthalate, which are also known by the customary abbreviations DOP (dioctyl phthalate, di-2-ethylhexyl phthalate), DINP (diisononyl phthalate), DIDP (diisodecyl phthalate)
(ii) esters of aliphatic dicarboxylic acids, in particular esters of adipic, azelaic and sebacic acid, preferably di-2-ethylhexyl adipate and diisooctyl adipate
(iii) trimellitic acid esters, for example tri-2-ethylhexyl trimellitate, triisodecyl trimellitate (mixture), triisotridecyl trimellitate, triisooctyl trimellitate (mixture) and tri-C₆-C₈-alkyl, tri-C₆-C₁₀-alkyl, tri-C₇-C₉-alkyl and tri-C₉-C₁₁-alkyl trimellitates; customary abbreviations are TOTM (trioctyl trimellitate, tri-2-ethylhexyl trimellitate), TIDTM (tri-isodecyl trimellitate) and TITDTM (triisotridecyl trimellitate)
(iv) epoxy plasticizers; in the main, these are epoxidized unsaturated fatty acids, e.g. epoxidized soybean oil
(v) polymer plasticizers: the most commonly used starting materials for their preparation are dicarboxylic acids, such as adipic, phthalic, azelaic and sebacic acid; diols, such as 1,2-propanediol, 1,3-butanediol, 1,4-butanediol, 1,6-hexanediol, neopentylglycol and diethylene glycol (cf. ADMEX® types from Velsicol Corp. and PX-811 from Asahi Denka)
(vi) phosphoric acid esters: a definition of these esters is to be found in the abovementioned “TASCHENBUCH DER KUNSTSTOFFADDITIVE [POCKETBOOK OF PLASTICS ADDITIVES]”, Section 5.9.5, pages 408-412. Examples of such phosphoric acid esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, triphenyl phosphate, tricresyl phosphate and trixylenyl phosphate; tri-2-ethylhexyl phosphate and Reofos® 50 and 95 (Ciba Spezialitätenchemie) are preferred
(vii) chlorinated hydrocarbons (paraffins)
(viii) hydrocarbons
(ix) monoesters, e.g. butyl oleate, phenoxyethyl oleate, tetrahydrofurfuryl oleate and alkanesulfonic acid esters
(x) glycol esters, e.g. diglycol benzoates
(xi) citric acid esters, e.g. tributyl citrate and acetyltributyl citrate, as described in WO 02/05206
(xii) perhydrophthalic, perhydroisophthalic and perhydroterephthalic esters and perhydroglycol and diglycol benzoate esters; perhydrodiisononyl phthalate is preferred (Hexamoll® DINCH—manufacturer BASF), as described in DE 197 56 913 A1, DE 199 27 977 A1, DE 199 27 978 A1 and DE 199 27 979 A1.

A definition of these plasticizers and examples of them are given in “TASCHENBUCH DER KUNSTSTOFFADDITIVE [POCKETBOOK OF PLASTICS ADDITIVES]”, R. Gächter/H. Müller, Carl Hanser Verlag, 3rd Edition, 1989, Section 5.9.6, pages 412-415, and in “PVC TECHNOLOGY”, W. V. Titow, 4^{th} Ed., Elsevier Publ., 1984, pages 165-170. It is also possible to use mixtures of different plasticizers. The plasticizers can be used in an amount of, for example, from 5 to 50 parts by weight, expediently from 10 to 45 parts by weight, based on 100 parts by weight of PVC. Rigid or semirigid PVC can preferably comprise up to 20%, particularly preferably up to 5%, of plasticizer or no plasticizer.

### Pigments

Suitable substances are known to the person skilled in the art. Examples of inorganic pigments are TiO₂, zirconium oxide-based pigments, BaSO₄, zinc oxide (zinc white) and lithopone (zinc sulfide/barium sulfate), carbon black, carbon black/titanium dioxide mixtures, iron oxide pigments, Sb₂O₃, (Ti,Ba,Sb)O₂, Cr₂O₃, spinels, such as cobalt blue and cobalt green, Cd(S,Se) and ultramarine blue. Organic pigments are, for example, azo pigments, phthalocyanine pigments, quinacridone pigments, perylene pigments, diketopyrrolopyrrole pigments and anthraquinone pigments. TiO₂ is preferred, also in micronized form. A definition and further descriptions are to be found in “HANDBOOK OF PVC FORMULATING”, E. J. Wickson, John Wiley & Sons, New York, 1993.

### Antioxidants

These include sterically hindered phenols, such as alkylated monophenols, e.g. 2,6-di-tert-butyl-4-methylphenol, alkylthiomethylphenols, e.g. 2,4-dioctylthiomethyl-6-tert-butylphenol, alkylated hydroquinones, e.g. 2,6-di-tert-butyl-4-methoxyphenol, hydroxylated thiodiphenyl ethers, e.g. 2,2′-thiobis(6-tert-butyl-4-methylphenol), alkylidenebisphenols, e.g. 2,2′-methylenebis(6-tert-butyl-4-methylphenol), benzyl compounds, e.g. 3,5,3′,5′-tetra-tert-butyl-4,4′-dihydroxydibenzyl ether, hydroxybenzylated malonates, e.g. dioctadecyl 2,2-bis(3,5-di-tert-butyl-2-hydroxybenzyl)malonate, hydroxybenzyl aromatics, e.g. 1,3,5-tris(3,5-di-tert-butyl-4-hydroxybenzyl)-2,4,6-tri-methylbenzene, triazine compounds, e.g. 2,4-bisoctylmercapto-6-(3,5-di-tert-butyl-4-hydroxyanilino)-1,3,5-triazine, phosphonates and phosphonites, e.g. dimethyl 2,5-di-tert-butyl-4-hydroxybenzyl phosphonate, acylaminophenols, e.g. 4-hydroxylauranilide, esters of beta-(3,5-di-tert-butyl-4-hydroxyphenyl)propionic acid, of beta-(5-tert-butyl-4-hydroxy-3-methylphenyl)propionic acid and of beta-(3,5-dicyclohexyl-4-hydroxyphenyl)propionic acid, esters of 3,5-di-tert-butyl-4-hydroxyphenylacetic acid with monohydric or polyhydric alcohols, amides of beta-(3,5-di-tert-butyl-4-hydroxyphenyl)propionic acid, e.g. N,N′-bis(3,5-di-tert-butyl-4-hydroxyphenylpropionyl)hexamethylenediamine, Vitamin E (tocopherol) and derivatives. The antioxidants can be used in an amount of, for example, from 0.01 to 10 parts by weight, expediently from 0.1 to 10 parts by weight and in particular from 0.1 to 5 parts by weight, based on 100 parts by weight of PVC.

### UV Absorbers and Light Stabilizers

Examples of these are 2-(2′-hydroxyphenyl)benzotriazoles, e.g. 2-(2′-hydroxy-5′-methylphenyl)benzotriazole, 2-hydroxybenzophenones, esters of optionally substituted benzoic acids, e.g. 4-tert-butylphenyl salicylate, phenyl salicylate, acrylates, nickel compounds, oxalamides, e.g. 4,4′-dioctyloxyoxanilide, 2,2′-dioctyloxy-5,5′-di-tert-butyloxanilide, 2-(2-hydroxyphenyl)-1,3,5-triazines, e.g. 2,4,6-tris(2-hydroxy-4-octyloxyphenyl)-1,3,5-triazine, 2-(2-hydroxy-4-octyloxyphenyl)-4,6-bis(2,4-dimethyl-phenyl)-1,3,5-triazine, sterically hindered amines based on tetramethylpiperidine or tetramethylpiperazinone or tetramethylmorpholinone, e.g. bis(2,2,6,6-tetramethylpiperidin-4-yl)sebacate, bis(2,2,6,6-tetramethylpiperidin-4-yl) succinate and benzoxazinones, such as 1,4-bisbenzoxazinonylbenzene.

### Optical Brighteners

Examples of these are bisbenzene(1,4)oxazoles, phenylcoumarins and bisstyrylbiphenyls, such as 4-methyl-7-diethylaminocoumarin, 3-phenyl-7-(4-methyl-6-butoxybenzoxazole)coumarin, 4,4′-bis(benzoxazol-2-yl)stilbene and 1,4-bis(benzoxazol-2-yl)naphthalene. Solutions of optical brighteners in a plasticizer, for example DOP, are preferred.

### Blowing Agents

Blowing agents are, for example, organic azo and hydrazo compounds, tetrazoles, oxazines, isatic anhydride, N-methylisatic anhydride, and sodium carbonate and sodium bicarbonate. Azodicarbonamide and sodium bicarbonate and mixtures thereof are preferred. Isatic anhydride or N-methylisatic anhydride is very particularly preferred, especially in flexible PVC or semirigid PVC.

### Antistatic Agents

Antistatic agents are divided into nonionic(a), anionic(b), cationic(c) and amphoteric(d) classes. (a) includes fatty acid ethoxylates, fatty acid ester, ethoxylated fatty alkylamines, fatty acid diethanolamides and ethoxylated phenols and alcohols and polyglycol fatty acid monoesters. (b) includes alkali metal fatty alkanesulfonates and phosphoric acid bis-fatty alcohol ester alkali metal salts. (c) includes quaternary fatty alkylammonium salts and (d) includes fatty alkylbetaines and fatty alkylimidazolinebetaines. Individual preferred compounds are lauric acid diethanolamide, myristyldiethanolamine, sodium octadecylsulfonate and sodium bisoctadecyl phosphate. In many cases, the presence of component (A) permits a reduction in the amount of expensive antistatic agents used, owing to the inherent properties.

Definitions and examples of further additives, such as impact modifiers and processing aids, gelling agents, biocides, metal deactivators, flameproofing agents, antifogging agents and compatibilizers are described in “HANDBUCH DER KUNSTSTOFFADDITIVE [HANDBOOK OF PLASTICS ADDITIVES]”, R. Gächter/H. Müller, Carl Hanser Verlag, 3rd Edition, 1989, and 4^{th} Edition, 2001, and in “HANDBOOK OF POLYVINYL CHLORIDE FORMULATING”, E. J. Wickson, J. Wiley & Sons, 1993, and in “PLASTICS ADDITIVES”, G. Pritchard, Chapman & Hall, London, 1st Ed., 1998. Impact modifiers are furthermore described in detail in “IMPACT MODIFIERS FOR PVC”, J. T. Lutz/D. L. Dunkelberger, John Wiley & Sons, 1992. Further stabilizers may be phenylurea, 2-phenylindole, 3-hydroxyaniline and the N-phenyl derivatives thereof, 2-pyrrolecarboxylic acid (cf. in this context EP 1,299,466 A1), 2,4-diphenylpyrrole and 2-alkyl-4-phenylpyrrole-3-carboxylic acid esters, 3-amino-4-alkyl/phenylpyrrol-3-carboxylic esters and calcium hydroxyaluminum hydrogen phosphites (CHAP compounds, cf. EP 0,506,831 A1).

Stabilizer systems which additionally comprise acetacetein-substituted indole or a urea or an aniline derivative are also preferred. Examples of suitable compounds are 2-phenylindole, 2-phenyllaurylindole and N,N′-diphenylthiourea and phenylurea. Further examples are described in DE 101 07 329 A1. In this context, also see EP 0,768,336 A1, EP 0,174,412, EP 0,967,245 A1, EP 0,967,209 A1, EP 0,967,208 A1, EP 0,962,491 A1, EP 1,044,968 A1, WO 02/072 684 and WO 02/048 249.

A particular preference lies in the combination of the mixtures (A-1, A-2)/(B-1, B-2) with phosphite esters, the additional phosphite being distearyl pentaerythrityl diphosphite, triphenyl phosphite, trisnonylphenyl phosphite, phenyl didecyl phosphite, poly(dipropylene glycol) phenyl phosphite, tetraphenyl dipropylene glycol diphosphite, tetraisodecyl dipropylene glycol diphosphite, tris(dipropylene glycol) phosphite, decyl diphenyl phosphite, trioctyl phosphite, trilauryl phosphite or (nonylphenyl_{1.5}-C₁₂/C₁₃-alkyl)_{1.5} phosphite.

The invention furthermore relates to compositions which comprise a chlorine-containing polymer and a stabilizer system according to the invention. In these compositions, the compounds of the general formulae (A-1/A-2) and (B-1/B-2) are to be used for achieving stabilization in the chlorine-containing polymer, expediently in an amount of from 0.01 to 10, preferably from 0.05 to 5, based on 100 parts by weight of polymer. The salts (C-1), (C-2) and (C-3) can be used in an amount of, for example, from 0.001 to 10, expediently from 0.01 to 5, particularly preferably from 0.01 to 3, parts by weight, based on 100 parts by weight of polymer. Compositions in which the ratio of the compound of the general formulae (A) and (B) to the salt (C-1), (C-2) and (C-3) is in the range from 2:8:1 to 5:20:1, based on the weight, are preferred.

Preferred compositions comprise, based on 100 parts by weight of the chlorine-containing polymer, 0.01-10 parts by weight of the compound (A-1) and/or (A-2) and 0.01-10 parts by weight of the compound (B-1) and/or (B-2).

Furthermore, compositions according to the invention preferably additionally comprise 0.01-10 parts by weight of the compound (E1) or (E2).

Furthermore, compositions according to the invention preferably comprise, based on 100 parts by weight of chlorine-containing polymer, additionally 0.001-5 parts by weight of a perchlorate salt (C-1).

Examples of the chlorine-containing polymers to be stabilized are polymers of vinyl chloride, of vinylidene chloride, vinyl resins comprising vinyl chloride units in their structure, such as copolymers of vinyl chloride and vinyl esters of aliphatic acids, in particular vinyl acetate, copolymers of vinyl chloride with esters of acrylic and methacrylic acid and with acrylonitrile, copolymers of vinyl chloride with diene compounds and unsaturated dicarboxylic acids or their anhydrides, such as copolymers of vinyl chloride with diethyl maleate, diethyl fumarate or maleic anhydride, postchlorinated polymers and copolymers of vinyl chloride, copolymers of vinyl chloride and of vinylidene chloride with unsubstituted aldehydes, ketones and others, such as acrolein, crotonaldehyde, vinyl methyl ketone, vinyl methyl ether, vinyl isobutyl ether and the like; polymers of vinylidene chloride and copolymers thereof with vinyl chloride and other polymerizable compounds; polymers of vinyl chloroacetate and of dichlorodivinyl ether; chlorinated polymers of vinyl acetate, chlorinated polymeric esters of acrylic acid and of alpha-substituted acrylic acid; polymers of chlorinated styrenes, for example dichlorostyrene; chlorinated rubbers; chlorinated polymers of ethylene; polymers and postchlorinated polymers of chlorobutadiene and copolymers thereof with vinyl chloride, chlorinated natural and synthetic rubbers, and blends of said polymers with themselves or with other polymerizable compounds. In the context of this invention, PVC is also to be understood as meaning copolymers of vinyl chloride with polymerizable compounds, such as acrylonitrile, vinyl acetate or ABS, it being possible for these to be suspension, mass or emulsion polymers.

A PVC homopolymer is preferred, even in combination with polyacrylates or polymethacrylates.

Furthermore, graft polymers of PVC with EVA, ABS and MBS are also suitable, as are graft polymers of PVC with PMMA. Preferred substrates are also blends of the abovementioned homo- and copolymers, in particular vinyl chloride homopolymers, with other thermoplastic and/or elastomeric polymers, in particular blends with ABS, MBS, NBR, SAN, EVA, CPE, MBAS, PMA, PMMA, EPDM and polylactones, in particular from the group consisting of ABS, NBR, NAR, SAN and EVA. The related abbreviations for the copolymers are familiar to the person skilled in the art and have the following meaning: ABS acrylonitrile-butadiene-styrene; SAN styrene-acrylonitrile; NBR acrylonitrile-butadiene; NAR acrylonitrile-acrylate; EVA ethylene-vinyl acetate. Acrylate-based styrene-acrylonitrile copolymers (ASA) are also particularly suitable. In this context, polymer compositions which comprise a blend of 25-75% by weight of PVC and 75-25% by weight of said copolymers as components (i) and (ii) are preferred as a component. Of particular importance as a component are compositions of (i) 100 parts by weight of PVC and (ii) 0-300 parts by weight of ABS and/or SAN-modified ABS and 0-80 parts by weight of the copolymers NBR, NAR and/or EVA, but in particular EVA.

Furthermore, in particular recycled chlorine-containing polymers are also suitable for stabilization in the context of this invention, it being possible here for these to be the polymers which are described in more detail above and have been damaged by processing, use or storage. Recycled PVC is particularly preferred. A further use of the stabilizer combinations according to the invention is based on the possibility of imparting antistatic properties to the finished article comprising rigid or flexible PVC. In this way, it is possible to reduce the use of expensive antistatic agents. Flexible PVC or semirigid PVC is preferred for this application.

The invention furthermore relates to commodities (utility articles) which comprise PVC and systems according to the invention.

The use of utility articles which are distinguished by a particularly fine foam structure is also preferred. This is true of rigid, flexible and semirigid PVC. This aspect is particularly important in the case of wallpapers and floors of flexible PVC. Usually, heavy metal compounds, such as Zn or Sn stabilizers, are required as kickers for achieving a fine foam. Surprisingly, it was found that addition of tertiary alkanolamines (TEA, TIPA) to the compounds (A-1)/(A-2) and (B-1)/(B-2) has a kicker effect on isatic anhydride or N-methylisatic anhydride, which ensures the achievement of a fine foam structure.

It was also not foreseeable that the electrical resistance properties of a utility article which comprises an Mg, Ca or Al salt instead of an alkali metal salt as component (C-1), (C-2) or (C-3) are dramatically improved, which proves to be advantageous particularly in cable and insulator production and in applications in the semiconductor sector.

The compounds which can be concomitantly used and the chlorine-containing polymers are generally known to a person skilled in the art and are described in detail in “HANDBUCH DER KUNSTOFFADDITIVE [HANDBOOK OF PLASTICS ADDITIVES]”, R. Gächter/H. Müller, Carl Hanser Verlag, 3rd Edition, 1989, and 4th Edition, 2001, in DE 197 41 778 A1 and EP 0,967,245 A1, which are hereby incorporated by reference.

The stabilization according to the invention is suitable both for chlorine-containing polymer compositions which are unplasticized or plasticizer-free or substantially plasticizer-free compositions and for plasticizer compositions. Applications in rigid PVC or semirigid PVC are particularly preferred.

The compositions according to the invention are particularly suitable, in the form of rigid formulations, for hollow bodies (bottles), packaging films (thermoformed films), blown films, “Crash Pad” films (automobiles), pipes, foams, heavy profiles (windowframes), light wall profiles, construction profiles, films (including those produced by the Luvitherm process), profiles, sidings, fittings, office transparencies and apparatus housings, insulators, computers, components of household appliances and for electronics applications, in particular the semiconductor sector. They are very particularly suitable for the production of window profiles having a high degree of whiteness and surface gloss.

Other preferred compositions in the form of semirigid and flexible formulations are suitable for wire sheaths, cable insulations, decorative films, roof sheeting, foams, agricultural sheeting, tubes, sealing profiles, floors, wallpapers, automotive parts, soft films, injection molded parts, office transparencies and sheeting for inflated structures. Examples of the use of the compositions according to the invention as plastisols are artificial leather, floors, textile coatings, wallpapers, coil coatings and underbody protection for motor vehicles. Examples of sintered PVC applications of the compositions according to the invention are slush, slush mold and coil coatings and, in E-PVC, for films produced by the Luvitherm process. For further details in this context, see “KUNSTSTOFFHANDBUCH PVC [PVC PLASTICS HANDBOOK]”, Volume 2/2, W. Becker/H. Braun, 2nd Edition, 1985, Carl Hanser Verlag, pages 1236-1277.

The components (A-1)/(A-2) and (B-1)/(B-2) can be premixed together with other stabilizers or additives or PVC substrate, it preferably being possible for alkaline earth metal hydroxides, zeolites, hydrotalcites, hydrocalumites or catoites to be present as further stabilizers. So-called hotmixers which operate in a temperature range from 80° C. to 120° C. are very particularly preferred here. Optimum homogenization is achieved thereby. In the presence of PVC powders, stabilizers and further additives diffuse into the PVC particle. The presence of relatively small amounts of water does not have an adverse effect here but in certain circumstances even has a positive effect. One variant consists in carrying out the mixing process in a lubricant melt which may comprise calcium stearate or magnesium laurate or stearate or (hydroxy)stearic acid, in the presence of a calcium or magnesium hydroxide, of a basic magnesium, calcium or aluminum salt or of “overbased” compounds of magnesium and of calcium or of a polyol or of a zeolite, maltitol, lactitol, palatinitol or zeolite A, calcium hydroxide, a basic calcium or magnesium salt or an “overbased” compound of magnesium or calcium being preferred.

The embodiment in which the components (A-1) and/or (A-2) are initially introduced in this melt and the components (B-1) and/or (B-2) are metered in is particularly preferred, it being possible for the components (D) and (E) to be present in the premix.

In another variant, the incorporation of the stabilizers can be expediently be effected by the following method: as an emulsion or dispersion (one possibility is, for example, the form of a pasty mixture, the advantage of the system according to the invention in this administration form being the stability of the paste); as a dry blend during the mixing of additional components or polymer blends; by direct addition to the processing apparatus (e.g. calender, mixer, kneader, extruder and the like) or as a solution or melt or as flakes or pellets in dust-free form as a one-pack. Premixes of the components (A-1)/(A-2) with (B-1)/(B-2) and (C) and optionally (D) and/or (E) in compacted form in granulation apparatuses are particularly preferred, the non-dusting, nontacky, free-flowing granules which can be very easily digested during mixing with, for example PVC and during the processing process being obtained. A major advantage is to add, during the compounding (compacting or spray process), binders which preferably consist of cellulose ethers or cellulose esters (mainly hydroxyethyl-, hydroxypropyl- and hydroxypropylmethylcellulose or carboxymethylcellulose). Alternatively, polyvinyl alcohol or polyvinylpyrrolidone may also be added.

The polymer stabilized according to the invention can be prepared in a manner known per se, for which purpose the stabilizer mixture according to the invention and optionally further additives are mixed with the polymer using apparatuses known per se, such as the abovementioned processing apparatuses. Here, the stabilizers can be added individually or as a mixture or in the form of so-called masterbatches.

The polymer stabilized according to the present invention can be brought into the desired form in known ways. Such methods are, for example, milling, calendering, extrusion, injection molding or spinning, and furthermore extrusion blowmolding. The stabilized polymer can also be processed to give foams. The invention therefore also relates to a method for the stabilization of chlorine-containing polymers by addition of the stabilizer mixture according to the invention to a chlorine-containing polymer, as well as articles which contain PVC which is stabilized by the stabilizer mixtures according to the invention.

A further part of the invention consists in using the combinations of (A-1)/(A-2) and (B-1)/(B-2) for the prestabilization of in particular PVC. It is known that the PVC polymerization is carried out in an aqueous medium, and it is therefore necessary, before the further processing to give the finished article, to dry the polymer to give a powder, which is associated with thermal stress which leads to damage to the “virgin” polymer. It has now been found that addition of the systems according to the invention during the polymerization process leads to a reduction in the damage described. This effect makes it possible to reduce the amount of heat stabilizers, also those of the conventional type, in the post stabilization (actual heat stabilization), which leads to a financial saving and—from the environmental point of view—to protection of resources.

The compounds of the formulae (A-2), (B-1) and (B-2) are commercial products, and some of them are “bulk” chemicals. The compounds of the formula (A-1), namely [1], [12], [41] and [49], are likewise commercial products and are further used in industrial theobromine and caffeine synthesis.

The compounds (A-1) of the 6-iminobarbituric acid category are obtainable by relevant literature syntheses, and the following may be mentioned by way of example for [21] and [29]:
1. B. Gepner et al., J. Gen. Chem. U.S.S.R., 16, 179 (1946)
2. B. Bobranski et al., J. Am. Pharm. Assoc., Sci. Ed., 37, 42 (1948)
3. Henning-Laokoon Chem. Pharm. Werk DE 752,285 (13.7.1953)
4. Monsanto Chem. Corp. U.S. Pat. No. 2,827,461 (18.3.1958)
5. M. M. Kaganskii et al., Khim. Farm. Zh., 1, 49 (1967)
6. A. Lespagnol et al., Chim. Ther., 5, 321 (1970)
7. A. Maslankiewicz et al., Zesz. Nauk. Politech. Slask. Chem., 87, 81 (1979)
8. R. B. Mitra et al., Indian J. Chem., Sect. B., 28B, 968 (1989)
9. A. S. Rao et al., Indian J. Chem., Sect. B., 20B, 159 (1981)
10. S. Ganaphthy, Chem. Eng. World, XXXIII, No. 11, 110 (1998)

The invention furthermore relates to a method for the stabilization of chlorine-containing polymers by addition of a stabilizer mixture according to the invention to a chlorine-containing polymer, in particular to flexible PVC or paste PVC. The flexible PVC may be suitable for the production of floors, automotive parts, wallpapers, flexible films, tubes, injection molded parts or preferably for wire sheaths (cables). Alternatively, the chlorine-containing polymer may be a rigid PVC. The chlorine-containing polymer may also serve for the production of films (including Luvitherm), PVC pipes or profiles, preferably of window profiles. The invention furthermore relates to the use of stabilizer mixtures according to the invention for the prestabilization of chlorine-containing polymers, such as PVC.

The following examples describe the invention in more detail.

### EXAMPLES

Unless stated otherwise, data expressed in parts relate—as in the remaining description—to weight.

The following data expressed in parts are used in examples 1-3 (tab. 1).

TABLE 1
Data expressed in parts for stabilizer mixtures [use of
BI (A-1) and CA (B-2)*]

| No. | BI¹⁾ | AU²⁾ | MS³⁾ | HT⁴⁾ | CA | BO |
|---|---|---|---|---|---|---|
| 1 | — | 0.4 | 1.6 | — | — | — |
| 2 | — | 0.4 | 1.6 | — | — | 0.08⁶⁾ |
| 3 | — | 0.4 | — | 1.6 | — | — |
| 4 | 0.4 | — | — | — | 1.6^{5a)} | — |
| 5 | — | 0.4 | — | — | 1.6^{5a)} | — |
| 6 | 0.4 | — | — | — | 1.6^{5a)} | 0.08⁶⁾ |
| 7 | — | 0.4 | — | — | 1.6^{5a)} | 0.08⁶⁾ |
| 8 | 0.4 | — | — | — | 1.6^{5b)} | — |
| 9 | — | 0.4 | — | — | 1.6^{5b)} | — |
| 10 | 0.4 | — | — | — | 1.6^{5b)} | 0.08⁶⁾ |
| 11 | — | 0.4 | — | — | 1.6^{5b)} | 0.08⁶⁾ |

Legend:
¹⁾BI: Cycloureide (A-1), barbituramide - R¹ = R² = CH₃, X = O
²⁾AU: Linear acylureide (A-1), acylcarbamide - R¹ = R² = CH₃, X = O
³⁾MS: Molecular sieve (powder; 4 Å, ALDRICH), corresponding to Na zeolite A
⁴⁾HT: Hydrotalcite (ALDRICH)
^{5a)}CA: Cyanamide derivative (B-2) - R⁴ = H, m = 2; cyanoguanidine (dicyandiamide, MERCK)
^{5b)}CA: Cyanamide derivative (B-2) - R⁴ = H, m = 3; melamine (MERCK)
⁶⁾BO: Booster - Sodium perchlorate monohydrate (MERCK), dissolved in 10 ml of methanol
*= BI = 6-iminobarbituric acid, CA = cyanamides (cyanamide derivatives)

From Tab. 1, it is evident that the mixtures with the No. 1-3 correspond to the most obvious prior art (PrA), while the mixtures with the No. 4-11 are according to the invention.

### Example 1

### DHC Powder

A) Preparation of the Powder Samples

100 parts of PVC (K value 60, of the NORVINYL®-S6045 type) are initially introduced into a 500 ml round-bottomed flask, the additives BI, AK, MS, HT, CA and BO are then added according to Tab. 1, 100 ml of methanol are then added and the suspension is evaporated to dryness on a rotary evaporator up to not more than 60° C. The powders thus obtained are dried at 60° C. to constant weight in a drying oven.

B) Carrying Out the Dehydrochlorination (DHC)

The DHC is a measure of the HCl elimination of PVC under thermal stress. The hydrogen chloride eliminated is flushed with nitrogen gas into a receiver containing distilled water, and the increase in the conductivity is measured there in microsiemens per centimeter (μS/cm). Minute values (min) serve as characteristics. The longer the time interval for achieving a certain conductivity, the more heat-stable is the PVC sample.

Apparatus type: PVC Thermomat 763 (measurement according to DN 53381 1-Part 1, method B: conductivity measurement)

| | | |
|---|---|---|
| Parameter: | Sample weight taken: | 500 ± 5 mg |
| | Temperature: | 180° C. |
| | Flow: | 7 l/h (nitrogen 5.0) |
| | Absorption volume: | 60 ml (demineralized water) |
| | Evaluation: | t₁₀, t₅₀ and t₂₀₀ (conductivity |
| | | of 10, 50 and 200 μS/cm - data |
| | | in minute values) |

Measurement: After the powder samples have been weighed into the reaction vessels, the measuring vessels are filled with demineralized water and equipped with conductivity electrodes. After the measuring temperature (180° C.) has been reached, the closed reaction vessels are transferred to the heating block and coupled via the corresponding tube connections to the measuring vessels, and the measurement is started. The t₁₀, t₅₀ and t₂₀₀ values serve as stability criteria. Results of the experimental series are summarized in Tab. 2.

TABLE 2
DHC values/powder samples (selection)

| No. | t₁₀ [min]⁷⁾ | t₅₀ [min]⁷⁾ | t₂₀₀ [min]⁷⁾ |
|---|---|---|---|
| 1 | 37 | 46 | 58 |
| 2 | 48 | 58 | 74 |
| 3 | 44 | 52 | 64 |
| 4 | 72 | 78 | 85 |
| 5 | 69 | 74 | 81 |
| 6 | 69 | 74 | 84 |
| 7 | 104 | 127 | 163 |
| 10 | 104 | 143 | 179 |
| 11 | 127 | 169 | 199 |

Legend:
⁷⁾Minute values for achieving the conductivity of 10, 50 and 200 μS/cm

It is evident that the powder samples according to the invention (No. 4-11) are more heat-stable than powder samples according to PrA (No. 1-3) and have higher minute values. The powder samples according to the invention, No. 7, 10 and 11, give outstanding results.

### Example 2

### DHC Mill Hides⁸⁾

A) Production of the mill hides:

100 parts of the dry blends prepared according to 1A are each plasticated for 5 minutes at 180° C. with addition of 0.5-0.8 part⁹⁾ of a paraffin-based lubricant on a Collin laboratory measuring roll mill¹⁰⁾. The sheets thus obtained (thickness 0.3 mm) are used for further measurements.

### B) Carrying Out the DHC:

Pieces of mill hide (2×2 mm) were cut out of the hides. Altogether, 500±10 mg were tested. The test procedure and test conditions are described in example 1B. The results are summarized in Tab. 3.

TABLE 3
DHC values/sheet samples

| No. | t₁₀ [min] |
|---|---|
| 1 | 32 |
| 2 | 103 |
| 3 | 40 |
| 4 | 62 |
| 5 | 55 |
| 6 | 110 |
| 7 | 104 |
| 11 | 109 |

### Legend

8) Selection of powder samples
9) Depending on tendency to adhere
10) BJ: 92; Roll temp. (front): 182° C., (rear): 184° C.; roll diameter: 150 mm; roll circumference:
0.417 m; mixing speed: 15 [rpm]

It is evident that the samples according to the invention (No. 4, 5 and 6, 7, 11) have a better or comparable performance in comparison with the unboosted and with the boosted samples of the PrA (No. 1, 3 and 2).

### Example 3

### Static Heat Test¹¹⁾

11) Selection of mill hides

Test strips (16 mm×300 mm) are cut out of the mill hides produced according to example 2A. Said test strips are subjected to 180° C. in a Mathis thermotester (type LTE-T; feed: 5 mm, base time 5 or 45 min, cycle time 5 min) until dark discoloration occurs (combustion). Thereafter, the YI value (yellowness index) is determined according to ASTM-1925-70¹²⁾ and compared with the YI value of the mill hide not subjected to thermal stress (zero minute value). The results are summarized in Tab. 4a and 4b. 12) Spectrophotometer from HunterLab UltraScan XE

TABLE 4a
Static heat test of the unboosted samples (min)

| No. | 0 | 5 | 10 | 15 | 20 | 25 | 30 | 35 | 40 | 45 | 50 | 55 | 60 | 65 | 70 |
|---|---|---|---|---|---|---|---|---|---|---|---|---|---|---|---|
| 1 | 12.4 | 14.6 | 13.5 | 14.2 | 17.0 | 19.4 | 21.7 | 23.8 | 26.9 | 30.3 | 35.1 | 41.6 | 51.6 | 85.1 | 108.8 |
| 4 | 11.4 | 10.7 | 13.0 | 13.7 | 14.6 | 15.8 | 16.8 | 18.9 | 20.5 | 23.2 | 26.7 | 32.4 | 39.8 | 50.1 | 61.9 |
| 8 | 13.2 | 14.2 | 13.5 | 13.8 | 13.6 | 14.7 | 17.2 | 17.2 | 19.2 | 20.8 | 22.6 | 25.2 | 28.6 | 35.3 | 80.1 |

TABLE 4b
Static heat test of the boosted samples (min)

| No. | 0 | 45 | 50 | 55 | 60 | 65 | 70 | 75 | 80 |
|---|---|---|---|---|---|---|---|---|---|
| 2 | 9.0 | 8.9 | 9.3 | 9.4 | 10.8 | 12.4 | 15.5 | 17.8 | 20.3 |
| 6 | 5.2 | 5.8 | 6.5 | 6.4 | 7.5 | 9.1 | 12.1 | 14.6 | 17.9 |

Tab. 4a shows an improvement in the initial color (IC)—5 min value—and in the color retention (CR) and the long-term stability (LS)—10 to 70 min value—of the samples according to the invention (No. 4 and 8) in comparison with the PrA (No. 1).

Tab. 4b shows a major improvement in the IC (zero minute and five minute value) and in the CR and LS—45 to 80 min value—of the sample according to the invention (No. 6) in comparison with the PrA (No. 2).

The following data expressed in parts are used in example 4 (cf. Tab. 5).

TABLE 5
Data expressed in parts for stabilizer mixtures [use of
BI (A-1) and PE (B-1)*]

| No. | BI¹⁾ | AU²⁾ | BE³⁾ | PE | BO |
|---|---|---|---|---|---|
| 12 | 0.4 | — | 1.6 | — | — |
| 13 | — | 0.4 | 1.6 | — | — |
| 14 | 0.4 | — | 1.6 | — | 0.08⁵⁾ |
| 15 | — | 0.4 | 1.6 | — | 0.08⁵⁾ |
| 16 | 0.4 | — | — | 1.6^{4a)} | — |
| 17 | 0.4 | — | — | 1.6^{4a)} | 0.08⁵⁾ |
| 18 | 0.4 | — | — | 1.6^{4b)} | — |
| 19 | 0.4 | — | — | 1.6^{4b)} | 0.08⁵⁾ |
| 20 | 0.4 | — | — | 1.6^{4c)} | — |
| 21 | 0.4 | — | — | 1.6^{4c)} | 0.08⁵⁾ |
| 22 | 0.4 | — | — | 1.6^{4d)} | — |
| 23 | 0.4 | — | — | 1.6^{4d)} | 0.08⁵⁾ |
| 24 | 0.4 | — | — | 1.6^{4e)} | — |
| 25 | 0.4 | — | — | 1.6^{4e)} | 0.08⁵⁾ |
| 26 | 0.4 | — | — | 1.6^{4f)} | — |
| 27 | 0.4 | — | — | 1.6^{4f)} | 0.08⁵⁾ |
| 28 | 0.4 | — | — | 1.6^{4g)} | — |
| 29 | 0.4 | — | — | 1.6^{4g)} | 0.08⁵⁾ |
| 30 | 0.4 | — | — | 1.6^{4h)} | — |
| 31 | 0.4 | — | — | 1.6^{4h)} | 0.08⁵⁾ |

Legend:
¹⁾BI: Cycloureide (A-1), barbiturimide - R¹ = R² = CH₃, X = O
²⁾AU: Linear acylureide (A-1), acylcarbamide - R¹ = R² = CH₃, X = O
³⁾BE: Bisphenol A diglycidyl ether (BADGE - ALDRICH)
^{4a)}PE: Trimethylolpropane trisepoxypropyl ether - R³ = trimethylolpropane-1,1,1-triyl; m = 3 (EMS-PRIMID, GRILONIT ® V51-31)
^{4b)}PE: Hexanediol bisepoxypropyl ether - R³ = hexane-1,6-diyl; m = 2 (EMS-PRIMID, GRILONIT ® RV 1812)
^{4c)}PE: 1,4-butanediol bisepoxypropyl ether - R³ = butane-1,4-diyl; m = 2 (EMS-PRIMID, GRILONIT ® RV1806)
^{4d)}PE: Polyglyceryl monoepoxypropyl ether - R³ = polyglycerol-α,ω-triyl; m = 3 (UPPC, POLYPOX ® R11)
^{4f)}PE: Glyceryl trisepoxypropyl ether - R³ = propane-1,2,3-triyl; m = 3 (UPPC, POLYPOX ® R12)
^{4g)}PE: Pentaerythrityl tetrakisepoxypropyl ether - R³ = pentaerythrit-tetrayl; m = 4 (UPPC, POLYPOX ® R16)
^{4h)}PE: Glyceryl bisepoxypropyl ether - R³ = propanediyl; m = 2 (ALDRICH)
⁵⁾BO: Booster - sodium perchlorate monohydrate (MERCK) dissolved in 5 ml of butyldiglycol (BDG)
*= BI = 6-iminobarbituric acid, PE = polyepoxypropyl alcohol ether

It is evident from Tab. 5 that the mixtures 13 and 15 correspond to the most obvious prior art (PrA) while the mixtures 16-31 are according to the invention.

### Example 4

### DHC Powder

The powder samples are prepared as described in example 1, with the difference that 100 parts of PVC of the type VINNOLIT S3160 (K value 60) are used and, according to Tab. 5, the additives BI, AU, BE, PE and BO are added.

The DHC measurements are likewise carried out as described there.

The t₁₀ and t₅₀ values serve as a stability criteria. The results are summarized in Tab. 6.

TABLE 6
DHC values/powder samples*

| No. | t₁₀ [min]⁶⁾ | t₅₀ [min]⁶⁾ |
|---|---|---|
| 12 | 62 | 67 |
| 13 | 62 | 65 |
| 14 | 88 | 123 |
| 15 | 53 | 86 |
| 16 | 62 | 65 |
| 17 | 155 | 167 |
| 19 | 115 | 126 |
| 21 | 108 | 121 |
| 23 | 103 | 120 |
| 25 | 131 | 144 |
| 26 | 71 | 75 |
| 27 | 147 | 157 |
| 29 | 137 | 151 |
| 30 | 70 | 73 |
| 31 | 146 | 154 |

Legend:
*= Selection of powder mixtures
⁶⁾Minute values for achieving the conductivity of 10 or 50 μS.

It is evident that the comparison of the unboosted samples of the PrA (No. 12, 13) with the unboosted samples of the invention (No. 16, 26 and 30) in the t₁₀ and t₅₀ values shows an improvement.

Major improvements are found in comparison with the boosted samples of the PrA (No. 14, 15) with the boosted samples of the invention (No. 17, 19, 21, 23, 25, 27, 29 and 31), in particular with regard to the t₁₀ value, which is of decisive importance for use in practice.

The following data expressed in parts are used in example 5 (cf. Tab. 7)

TABLE 7
Data expressed in parts for stabilizer mixtures
[use of AC (A-2) and VA (B-2) or PE (B-1)*]

| No. | AC¹⁾ | ZA²⁾ | PE | BO |
|---|---|---|---|---|
| 32 | 0.4 | 1.6 | — | 0.08^{4a)} |
| 33 | 0.4 | 1.6 | — | 0.08^{4b)} |
| 34 | 0.4 | — | 1.6^{3a)} | 0.08^{4a)} |
| 35 | 0.4 | — | 1.6^{3b)} | 0.08^{4a)} |
| 36 | 0.4 | — | 1.6^{3c)} | 0.08^{4a)} |

Legend:
¹⁾AC: Polyaminocrotonic acid ester (A-2) − R³ = 1,4-C₄H₈; m = 2 (ALDRICH)
²⁾CA: Cyanamide derivative (B-2) − R⁴ = H; m = 2 (cyanoguanidine, MERCK)
^{3a)}PE: Glyceryl bisepoxypropyl ether (ALDRICH)
^{3b)}PE: Glyceryl trisepoxypropyl ether (UPPC, POLYPOX ™ R12)
^{3c)}PE: Pentaerythrityltetrakisepoxypropyl ether (UPPC, POLYPOX ™ R16)
^{4a)}BO: Booster - Sodium perchlorate monohydrate (MERCK), dissolved in 5 ml of butyldiglycol (BDG)
^{4b)}BO: Booster - Sodium triflate (ALDRICH), dissolved in 5 ml of butyldiglycol (BDG)
*AC = Aminocrotonate, CA = cyanamide derivative, PE = polyepoxypropyl alcohol ether

### Example 5

### DHC Values/Powder Samples

The powder samples are prepared as described in example 1, with the proviso that 100 parts of PVC, type VINNOLIT S3160 (K value 60) are used and, according to Tab. 7, the additives AC, ZA, PE and BO are added. The DHC measurements are likewise carried out as described there. The induction time t_{ind}, t₅₀ and the t₂₀₀ values serve as a stability criterion. The results are summarized in Tab. 8.

TABLE 8
DHC values/powder samples

| No. | t_{ind} [min] | t₅₀ [min]⁵⁾ | t₂₀₀ [min]⁵⁾ |
|---|---|---|---|
| 32 | 86 | 91 | 108 |
| 33 | 97 | 101 | 124 |
| 34 | 128 | 133 | 163 |
| 35 | 123 | 124 | 153 |
| 36 | 124 | 122 | 162 |

Legend:
⁵⁾Minute values for reaching 50, 200 μS/cm

It is evident that the novel combination has excellent performance in the heat stabilization of PVC powder.

1-36. (canceled)

37. A stabilizer system for chlorine-containing polymers containing a linear and/or cyclic ureide of the formula (A-1): 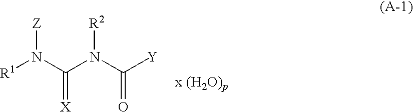
and
a cyanamide of the formula (B-2):
[R⁴₂NCN]ₙ (B-2)
where
X═O or S; Y═CH₂CN, Z=H or Y and Z form the bridge member CH₂—C═NH or CR⁵═C—NHR⁶;
n=1, 2 or 3; p=0, 1, 2 or 3
R¹, R²=independently of one another H, C₁-C₂₂-alkyl, cyclohexyl, allyl, oleyl, phenyl, benzyl, phenethyl, (tetrahydro)naphthyl, meth(eth)oxy(ethyl)propyl, CH₂—CHOH—R^{1a} or CH₂—CHOH—XR^{1a}
R^{1a}=H, C₁₋₂₂-alkyl, cyclohexyl, allyl, oleyl, phenyl, benzyl, phenethyl, (tetrahydro)naphthyl or meth(eth)oxy(ethyl)propyl;
R⁴=independently of one another H, nitrile, carbamoyl, R¹, R², R¹CO, R²CO, Na, K, Mg_{1/2} and Ca_{1/2} or R₂⁴=tetra-, penta- or hexamethylene;
R⁵═H or (C₃-C₁₀-alkylidene)_{1/2}, it being possible for this alkylidene to be interrupted by up to 2 O atoms or to have up to 2 substituents independently selected from the group consisting of OH, phenyl and hydroxyphenyl;
R⁶=H, hydroxy-C₂-C₄-alkyl, 3-C₁-C₁₀-alkoxy-2-hydroxypropyl or mono- to trihydroxy-, mono- to tri-C₁-C₄-alkyl- and/or mono- to tri-C₁-C₄-alkoxyphenyl, allyl, mono- to trisubstituted phenyl.

38. The stabilizer system as claimed in claim 37, characterized in that (A-1) is a cycloureide.

39. The stabilizer system as claimed in claim 38, characterized in that the cycloureide (A-1) is an N- or N′-monosubstituted or an (N,N′)-disubstituted 6(4)iminobarbituric acid.

40. The stabilizer system as claimed in claim 38, characterized in that the cycloureide (A-1) is a mono-(N or N′)-substituted or a di-(N,N′)-substituted 6(4)-aminouracil.

41. The stabilizer system as claimed in claim 39, characterized in that the 6(4)-aminouracil is present in hydrated form.

42. The stabilizer system as claimed in claim 37, characterized in that, in (A-1), R¹ or R² is methyl, ethyl, cyclohexyl, allyl, benzyl or hydrogen.

43. The stabilizer system as claimed in claim 37, characterized in that, in (A-1), R¹ or R is methyl, ethyl, cyclohexyl or benzyl.

44. The stabilizer system as claimed in claim 37, characterized in that, in (A-1), R¹ or R² is methyl, ethyl, cyclohexyl, allyl, benzyl or hydrogen and, in (B-2), R⁴ is hydrogen, C₁-C₄-alkyl, phenyl, formyl, acetyl, benzoyl or sodium or R₂⁴ is tetra- or pentamethylene or calcium.

45. The stabilizer system as claimed in claim 37, characterized in that, in (A-1), R¹ or R² is methyl, ethyl, cyclohexyl or benzyl and (B-2) is cyanamide, acetylcyanamide or the sodium or calcium salts thereof, dicyandiamide (cyanoguanidine) or 1,3,5-triaminotriazine (melamine).

46. The stabilizer system as claimed in claim 45, characterized in that dicyandiamide is used as (B-2).

47. The stabilizer system as claimed in claim 37, characterized in that (B-2) is cyanamide, acetylcyanamide, dicyandiamide (cyanoguanidine) or 1,3,5-triaminotriazine (melamine).

48. The stabilizer system as claimed in claim 37, characterized in that a perchlorate (C-1), perfluoroalkanesulfonate (C-2) or C₁-C₁₈-alkylsulfuric acid monoester salt (C-3) is present as component (C).

49. The stabilizer system as claimed in claim 48, characterized in that component (C) is an alkali metal or alkaline earth metal salt and the parent acid is perchloric acid, trifluoromethanesulfonic acid (triflic acid) or a mono-C₄-C₁₈-alkylsulfuric acid monoester.

50. The stabilizer system as claimed in claim 48, characterized in that (B-2) is cyanamide, acetylcyanamide, dicyandiamide (cyanoguanidine) or 1,3,5-triaminotriazine (melamine) and (C-1) is a perchlorate salt.

51. The stabilizer system as claimed in claim 37, characterized in that additionally one or more sterically hindered amines (D) containing the group (D-1) and/or cyclic sterically hindered amines, in particular of the formula (D-2), and/or tertiary ethanolamines (E) of the formulae (E-1) or (E-2): 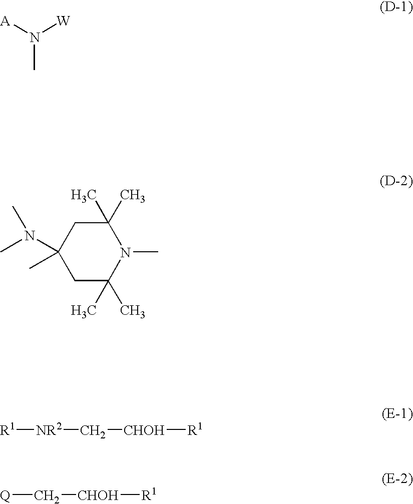
in which A and W, independently of one another, are C₁₋₈-alkyl, C₃₋₈-alkenyl, C₅₋₈-cycloalkyl or C₇₋₉-phenylalkyl or together form C₂₋₅-alkylene optionally interrupted by O, NH or CH₃—N, and
in which Q is 4- to 8-membered ring system which may be interrupted by one or two X atoms or NR¹ groups, and in which X, R¹ and R² independently have the meaning as in claim 1, are present.

52. The stabilizer system as claimed in claim 51, characterized in that the tertiary ethanolamine is triethanolamine, triisopropanolamine, triisobutanolamine, bisethanolisopropanol- or isobutanol-fatty amine or a monoadduct of a diethanolamine, of a diisopropanolamine or of a diisobutanolamine with an alkene oxide or a diadduct of a monoethanolamine, of a monoisopropanolamine or of a monoisobutanolamine with an alkene oxide.

53. The stabilizer system as claimed in claim 37, characterized in that an antioxidant is additionally present.

54. The stabilizer system as claimed in claim 53, characterized in that the antioxidant is a sterically hindered phenol.

55. The stabilizer system as claimed in claim 37, characterized in that calcium or magnesium stearate and/or, as a pigment, titanium dioxide or barium sulfate and/or, as a filler, chalk (coated or uncoated) is additionally present.

56. The stabilizer system as claimed in claim 37, characterized in that the chlorine-containing polymer is rigid or flexible PVC.

57. The stabilizer system as claimed in claim 56, characterized in that it is premixed in the presence of PVC.

58. The stabilizer system as claimed in claim 56, characterized in that it is used for the prestabilization of PVC polymers.

59. The stabilizer system as claimed in claim 56, characterized in that the PVC polymer is suspension or emulsion PVC.

60. A composition comprising a chlorine-containing polymer and a stabilizer system as claimed in claim 37.

61. The composition as claimed in claim 60, characterized in that, based on 100 parts by weight of chlorine-containing polymer, 0.01-10 parts by weight of the compound (A-1) and 0.01-10 parts by weight of the compound (B-2) are present.

62. The composition as claimed in claim 60, characterized in that 0.01-10 parts by weight of the compound (E1) or (E2) are additionally present.

63. The composition as claimed in claim 60, characterized in that, based on 100 parts by weight of chlorine-containing polymer, 0.001-5 parts by weight of a perchlorate salt (C-1) are additionally present.

64. A method for the stabilization of chlorine-containing polymers by addition of a stabilizer system as claimed in claims 37, to a chlorine-containing polymer.

65. The method for stabilization of chlorine-containing polymers as claimed in claim 64, characterized in that the chlorine-containing polymer is flexible PVC or paste PVC.

66. The method for the stabilization of chlorine-containing polymers as claimed in claim 65, characterized in that the flexible PVC is suitable for the production of floors, automotive parts, wallpapers, flexible sheets, tubes, injection-molded parts or preferably wire sheaths (cables).

67. The method for the stabilization of chlorine-containing polymers as claimed in claim 64, characterized in that the chlorine-containing polymer is rigid PVC.

68. The method for the stabilization of chlorine-containing polymers as claimed in claim 67, characterized in that the chlorine-containing polymer is suitable for the production of films (including Luvitherm), PVC pipes or profiles, preferably of window profiles.

69. A utility article comprising PVC, which is stabilized by a stabilizer system as claimed in claim 37.
